(19) United States
(12) Patent Application Publication
(10) Pub. No.: US 2014/0245014 A1
(43) Pub. Date: Aug. 28, 2014

(54) Remote control app for smart phones

(71) Applicants: Edward F. Tuck, West Covina, CA (US); Douglas R. Sallen, Monterey, CA (US); Douglas G. Lockie, Los Gatos, CA (US); Thomas N. Giaccherini, Carmel Valley, CA (US); Stig M. Pedersen, Los Angeles, CA (US); David K. Probst, Montreal (CA); Mark A. Sturza, Los Angeles, CA (US)

(72) Inventors: Edward F. Tuck, West Covina, CA (US); Douglas R. Sallen, Monterey, CA (US); Douglas G. Lockie, Los Gatos, CA (US); Thomas N. Giaccherini, Carmel Valley, CA (US); Stig M. Pedersen, Los Angeles, CA (US); David K. Probst, Montreal (CA); Mark A. Sturza, Los Angeles, CA (US)

(73) Assignee: Pascal's Pocket Corporation, West Covina, CA (US)

(21) Appl. No.: 13/998,828

(22) Filed: Dec. 10, 2013

Related U.S. Application Data
(63) Continuation-in-part of application No. 12/315,367, filed on Dec. 1, 2008, now Pat. No. 8,614,623.
Application No. 12/315,367 is a continuation-in-part of application No. 13/507,642, filed on Jul. 12, 2012, now abandoned.
Application No. 13/507,642 is a continuation-in-part of application No. 12/803,842, filed on Jul. 6, 2010, now abandoned.
Application No. 12/803,842 is a continuation-in-part of application No. 09/887,570, filed on Jun. 22, 2001, now abandoned.

(51) Int. Cl. H04L 12/28; H04L 9/08; H04W 12/04

(52) U.S. Cl. CPC H04L 12/282; H04W 12/04; H04L 9/0819; H04L 2012/2841; H04L 2012/285
USPC 713/171; 455/420

(57) ABSTRACT

Methods and apparatus for a Remote Control App for Smart Phones are disclosed. One embodiment of the present invention is a software application or “App” which may be downloaded to a conventional smart phone (12). Once downloaded to the smart phone (12) and to a remote computer, network or other information appliance (14), the smart phone (12) may be used to operate and/or control the remote computer, network or other information appliance.

### CROSS-REFERENCE TO RELATED PATENT APPLICATIONS CLAIMS FOR PRIORITY & INCORPORATION BY REFERENCE

The Present Continuation-in-Part patent application, and is based on Pending U.S. patent application Ser. No. 13/507,642, field 12 Jul. 2012 and U.S. Ser. No. 12/803,842, filed on 6 Jul. 2010. The Present application is also related to U.S. Provisional Patent Application U.S. Ser. No. 60/005,640, filed on 5 Dec. 2007; to U.S. Non-Provisional patent application Ser. No. 12/315,367, filed on 1 Dec. 2008; and to Ser. No. 09/887,570, filed on 22 Jun. 2001. The Applicants hereby claim the benefit of priority under Sections 119 and/or 120 of Title 35 of the United States Code of Laws for any subject matter which is commonly disclosed in the Present Continuation-in-Part application and in the Provisional and Non-Provisional applications identified in this paragraph.

The Applicants hereby incorporate all the text and drawings of U.S. Ser. No. 12/315,367 into the present Continuation-in-Part patent application.

The text and drawings of U.S. Ser. No. 12/455,963, which is shown in U.S. Patent Publication Number 2010/013 4247, and which was published on 3 Jun. 2010, is hereby incorporated by reference.

The text and drawings which describe the RainBarrel^{SM} Method, as shown in U.S. Patent Application Number 2002/004 2919, is also incorporated by reference.

The text and drawings which describe the UltraSecure^{SM} System, as shown in U.S. patent application Ser. No. 09/887,570, filed on 22 Jun. 2001, and in PCT International Patent Application No. PCT/GB02/05612, filed on 11 Dec. 2002, are also incorporated by reference.

### FEDERALLY SPONSORED RESEARCH OR DEVELOPMENT

None.

### FIELD OF THE INVENTION

The present invention pertains to methods and apparatus for a Remote Control App for Smart Phone. One embodiment of the present invention is a software application or “App” which may be downloaded to a conventional smart phone. Once downloaded to the smart phone and to a remote computer, network or other information appliance, the smart phone may be used to operate and/or control the remote computer, network or other information appliance.

### BACKGROUND OF THE INVENTION

Recent forecasts indicate that by the year 2015, 1.7 billion smart phones will be sold worldwide. In general, currently available or “conventional” smart phones are currently used to make telephone calls, to surf the Internet, to check e-mail, to play games or to enjoy content.

No device or software that is currently available offers the ability to convert a conventional smart phone to a remote control for computers or other information devices.

The development of a device or software that would offer these capabilities would constitute a major technological advance, and would satisfy long felt needs and aspirations in the computing, entertainment and telecommunications businesses.

### SUMMARY OF THE INVENTION

One embodiment of the invention provides a method for adding computing functionality to a conventional smart phone. The smart phone includes a central processing unit, or CPU. The CPU includes a non-volatile memory such as a solid state drive. This non-volatile memory is divided into a number of dynamic partitions, and each dynamic partition is assigned to a persona. A user's digital identity comprises one or more personas. Each persona may pertain to a different type of stored information or files, such as music, videos, books, documents or spreadsheets. Each of the dynamic partitions is protected by one or more access rules. When a group of smart phones is used in combination by a family, company or other organization, these access rules may be set by a group administrator. Access to personas within the group may also be determined by the group administrator.

The smart phone also includes a dynamic memory, a long range radio, and a short range radio. In one embodiment, these are random access memory, a cellular telephone radio and a BlueTooth radio.

A remote transmitter is connected to a server. The server includes a memory for storing an App. The App is conveyed from said server to the transmitter. The App is downloaded to the smart phone from the transmitter using the long range radio. The App is stored in the non-volatile memory of the smart phone. The App runs on the CPU of the smart phone. The App is then downloaded or transferred to a separate information appliance. The smart phone and the App are then used in combination to control the functions of the separate nearby information appliance using the short range radio.

An appreciation of the other aims and objectives of the present invention, and a more complete and comprehensive understanding of this invention, may be obtained by studying the following description of preferred and alternative embodiments, and by referring to the accompanying drawings.

### A BRIEF DESCRIPTION OF THE DRAWINGS

FIG. 1 is a schematic diagram which shows the download of a software application or “App” to a conventional smart phone from a wireless transmitter.

FIGS. 2A and 2B are additional diagrams, illustrating that the App is downloaded into the memory of the smart phone, and changes the state of the smart phone by enhancing its functions and capabilities.

FIG. 3 is a third diagram that reveals how the combination of the conventional smart phone and the downloaded App enable a user to control a computer, data environment or information appliance.

FIG. 4 is a perspective view of an after-market sleeve that may be used to envelop a conventional smart phone. The sleeve may provide additional memory and/or battery power for the smart phone.

FIG. 5 portrays an additional feature of the invention which provides restricted use based upon the GPS-derived location of the smart phone.

FIG. 6 offers a schematic view of an alternative embodiment of the invention, which provides “on-the-fly” communications with “unfriendly” information appliances.

FIG. 7 depicts one embodiment of the invention, which provides the user with a personal Cloud or a “Cloud in the pocket.”

FIG. 8 illustrates another embodiment of the invention, which provides “Cloud insurance.”

FIG. 9 offers a view of another embodiment of the invention, which supplies a method for replacing a lost or stolen smart phone. In one embodiment of the invention, the replacement device may already carry the operating system, software applications, data, files, content and information that were stored on the lost device.

FIG. 10 is a schematic block diagrams which illustrates the method steps which specify one embodiment of the invention.

FIG. 11 provides an illustration of how a family uses one embodiment of the present invention.

FIG. 12 shows each member of the family, together with their family digital identities. The digital identities comprise a number of personas.

FIG. 13 depicts one digital identity as a pie chart, which is divided into partitions or personas.

FIG. 14 explains access rules for partitions.

FIG. 15 shows how the manager and employees of a company may use one embodiment of the present invention.

FIG. 16 shows how the Group Administrator defines the partitions on the information appliances of each member of the company.

FIG. 17 furnishes a view of the Manager viewing the partitions on an employee's smart phone.

FIG. 18 shows how the present invention may be used by a number of employees to work together as a team.

FIG. 19 reveals the process for generating a report by drawing upon the contents of multiple partitions.

FIG. 20 shows how a smart phone can be programmed by its user, Mr. Jones, to include four Personas: Financial, Personal, Medical and Work. Data pertaining to each of these Personas may be stored on the smart phone, on a remote server, or both.

FIG. 21 shows that Mr. Jones' Four Personas may be stored in the Cloud, which could be accessed by other devices with the proper authorization.

FIG. 22 shows details of the information within each of the Four Personas. Each Persona may have a different level of security, and may be programmed with rules for access by other persons.

FIG. 23 shows two additional features: Inputs to Mr. Jones' smart phone may be backed up automatically, keystroke-by-keystroke, to a remote server. Also, if the smart phone is lost or stolen, Mr. Jones can call a telephone number, and, by entering a special code, instruct the remote server to permanently erase all the data in his smart phone.

FIG. 24 shows that the data in Mr. Jones smart phone may also be stored in a remote server in the Cloud; in a server at work; or in a PC at home.

FIG. 25 shows that after-market security modules may be connected to the smart phone which enhances its security.

FIG. 26 is a schematic diagram of a method and apparatus for the secure delivery of digital content.

FIG. 27 is a schematic diagram of additional details of the method and apparatus shown in FIG. 26.

### A DETAILED DESCRIPTION OF PREFERRED AND ALTERNATIVE EMBODIMENTS

### I. Overview of the Invention

One embodiment of the present invention combines a conventional smart phone 12 with a downloadable software application or “App”. This combination enables a user 10 to control and/or operate a computer or some other information appliance using the smart phone.

In this Specification and in the Claims that follow, the term “smart phone” refers to any currently-available, portable, wireless device, appliance or component which is used for communications, Internet or e-mail access, gaming or the viewing of content. The term “App” pertains to a software program 13 which may be downloaded over a wired or wireless connection to a smart phone 12, and then stored in the smart phone memory 15. The App 13 may also be transferred to one or more computers or other information appliances via a wired or wireless transmission. The terms “computer” and “information appliance” are intended to pertain to any device, system, or network which is physically separate from the smart phone 12 which is used to process information, communications, data or content. The term “Cloud” refers to any aggregation of hardware, systems, components and/or software that comprises a local or remote network.

### II. Downloading the App

In one embodiment of the invention, a user 10 obtains a conventional smart phone 12, and then visits a website running on a remote server 14. The user 10 opens an account on the website, and downloads the App 13 to his or her smart phone 12 over a wireless connection. This wireless connection may be a transmission from a cellular telephone network, a Wi-Fi or WiMax network, a Bluetooth® link, an optical or microwave connection, an LTE link or any other suitable wireless pathway 18. In an alternative embodiment, the user 10 may download the App 13 over a cable connected to a computer that has the App 13 stored in its memory 15.

Once the App 13 is stored in the non-volatile memory 15 of the smart phone. The download of the App 13 to the smart phone 12 changes the state of the smart phone 12, and now enables the smart phone 12 to perform functions that it previously could not perform.

After the App 13 is downloaded, the user 10 then downloads the same or a related App 13 to one or more personal computers or information appliances. The download 20 is stored in the non-volatile memory 15 of the computer or information appliance. This download 20 changes the state of the computer or information appliance. The personal computer or information appliance is now able to be controlled by the smart phone 12 which runs the same App. Once the App 13 is present on another of the user's computers or devices, that computer or device becomes a “friendly” device which is capable of operating in cooperation with the smart phone.

Depending on the capacity of the platform, the App 13 may require that the platform on which it is installed be augmented by the addition of an operating system (OS). This OS may be loaded into the platform's memory from a web site, or from an external memory device. Alternatively, the OS can remain on the memory device or website, server or other storage device or medium which is connected either physically (as with a USB connector) or wirelessly, and carry out its function in situ.

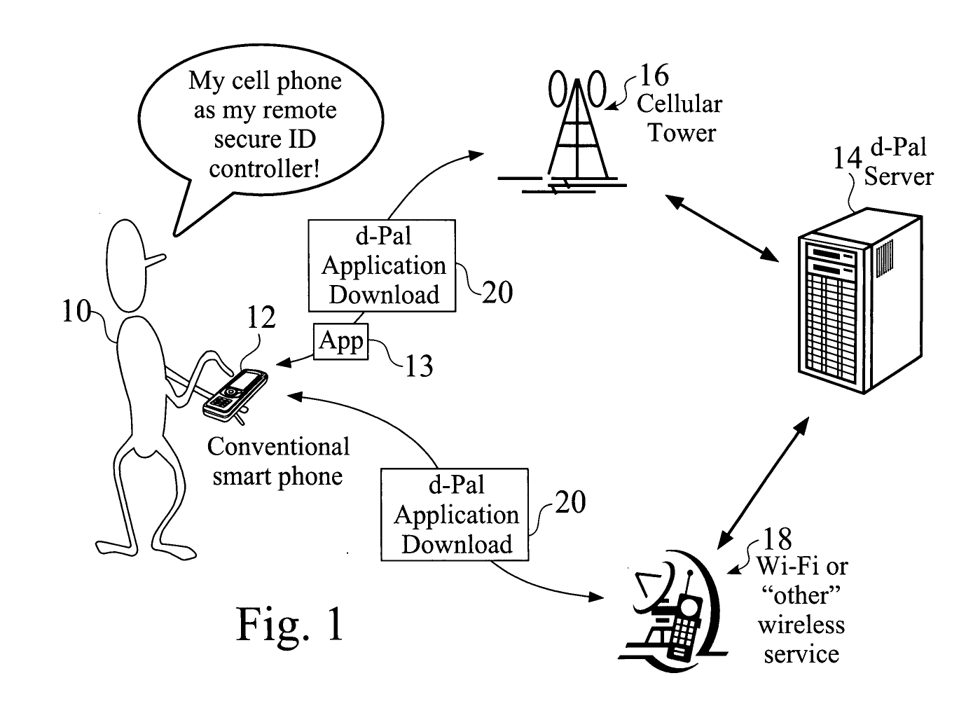

FIG. 1 shows the App 13 being downloaded from a cellular phone tower 16 or from a Wi-Fi transmitter 18. Both of these transmitters are connected to a remote server 14 that stores the App 13 in its memory 17.

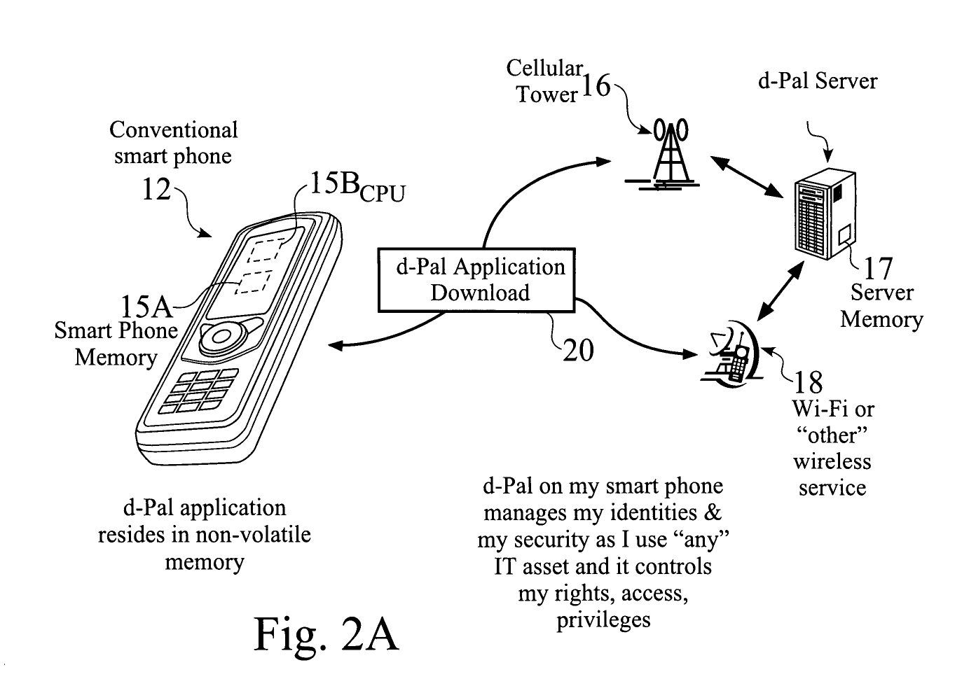

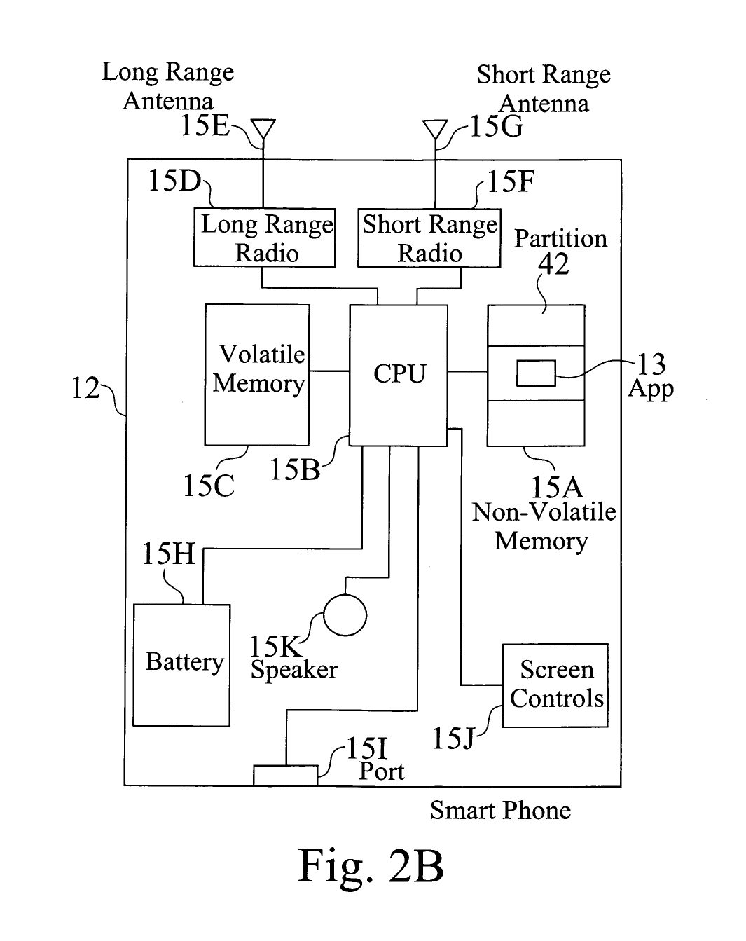

FIG. 2 depicts the wireless reception of the App, and the storage of the App 13 in the memory 15 of the smart phone.

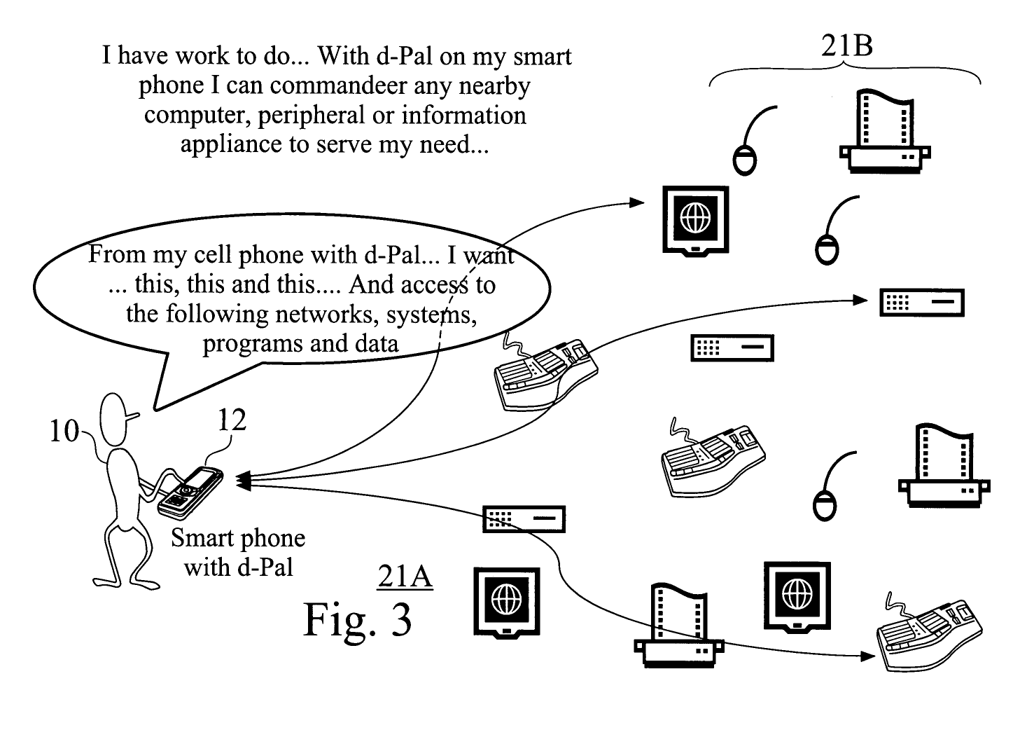

FIG. 3 provides an illustration 21 that depicts a user 10 who is now able to control his personal computer using the combination of the smart phone 12 and the App.

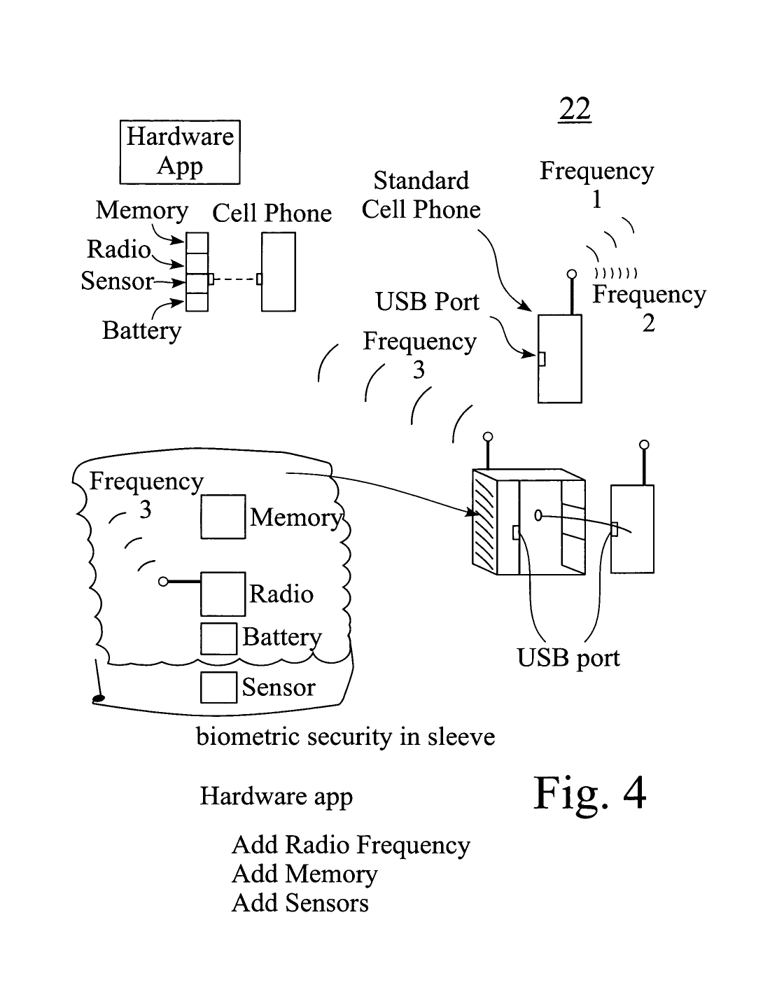

FIG. 4 supplies a view 22 of an after-market sleeve that may be used to envelop a conventional smart phone. The sleeve may provide additional memory 15 and or battery power for the smart phone.

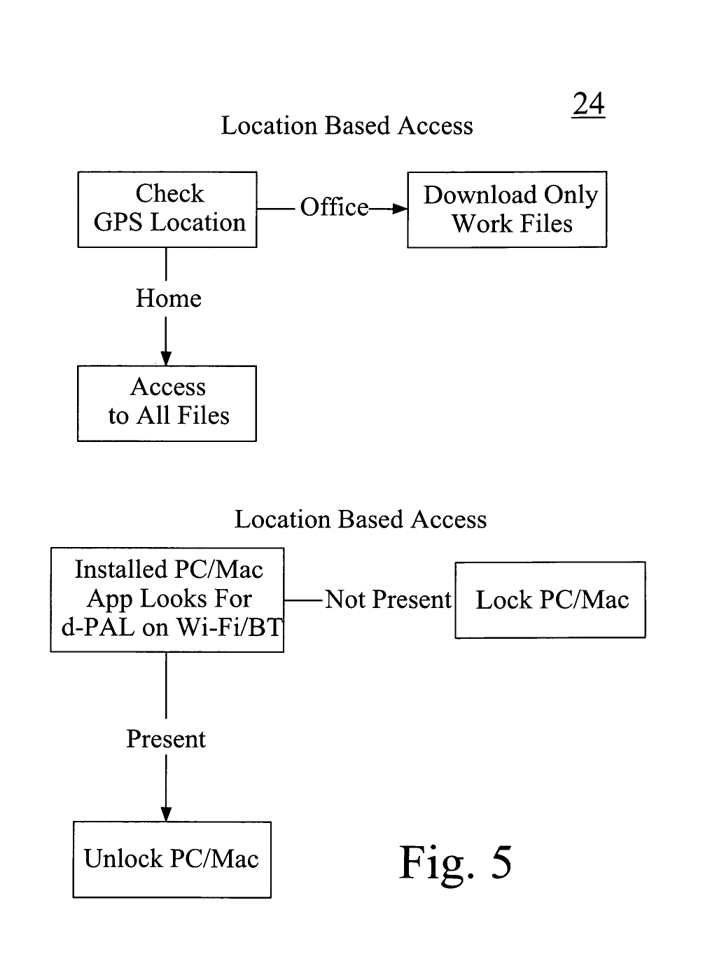

FIG. 5 supplies a view 24 of an additional feature of the invention which provides restricted use based upon the GPS-derived location of the smart phone.

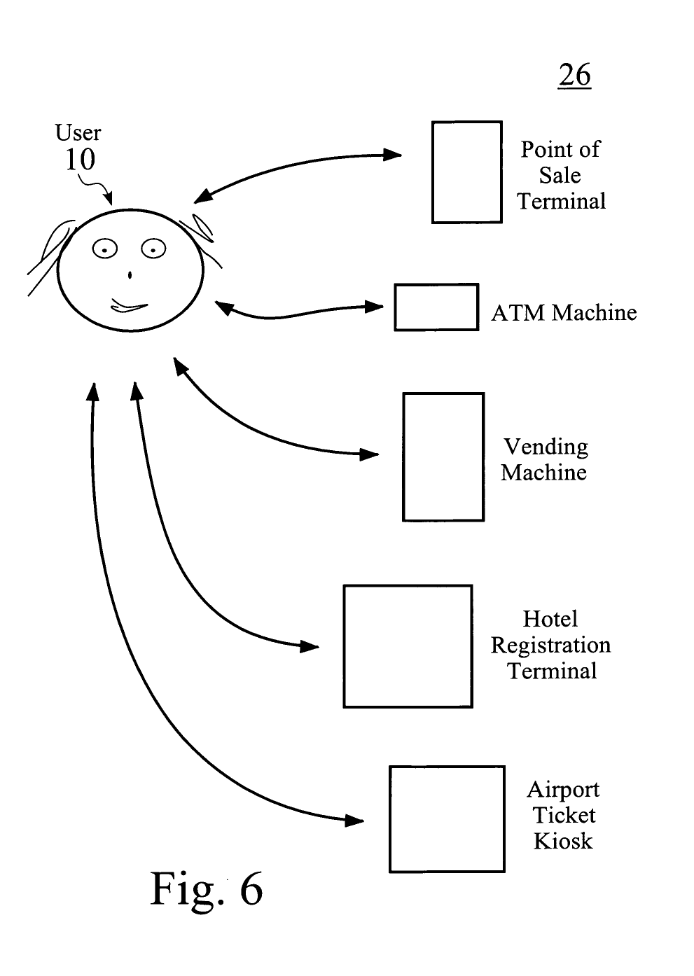

FIG. 6 offers a schematic view 26 of an alternative embodiment of the invention, which provides “on-the-fly” communications with “unfriendly” information appliances.

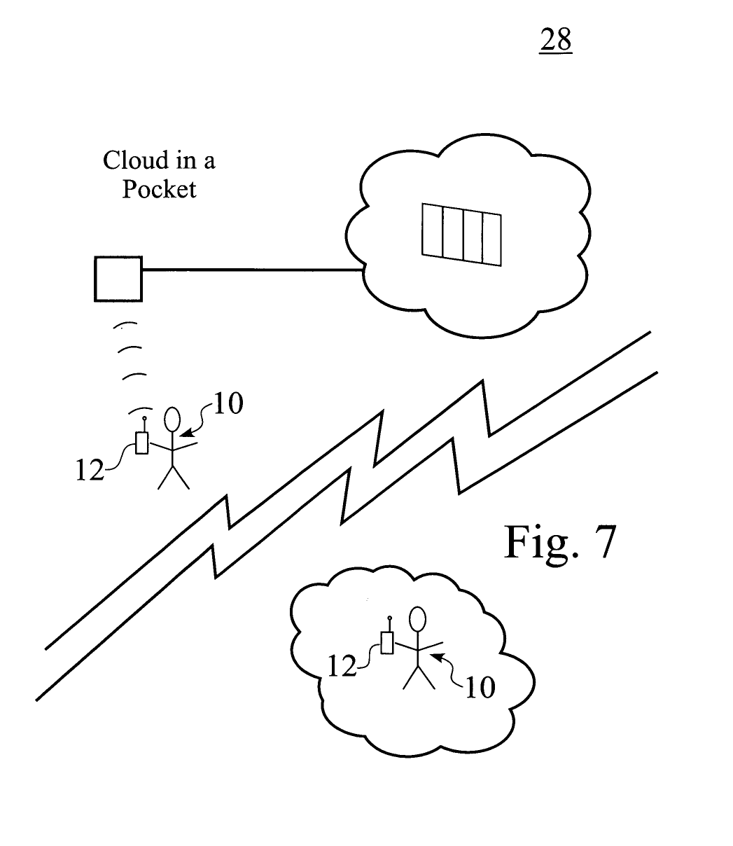

FIG. 7 offers a view 28 of one embodiment of the invention, which provides the user 10 with a “Cloud in the pocket.” Once the App 13 is downloaded, the smart phone 12 offers capabilities which were not previously available to the user 10. As an example, the user 10 need not depend upon the Cloud for software applications, data or content, since all of these may be stored securely in his or her own smart phone. The improved smart phone 12 essentially becomes the Cloud in the user's pocket.

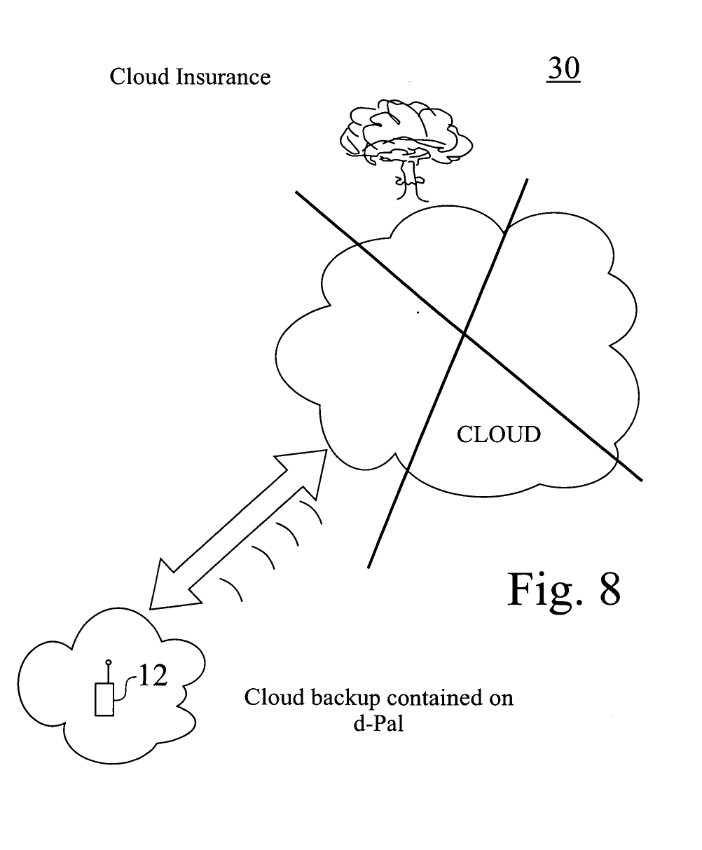

FIG. 8 is an illustration 30 of another embodiment of the invention, which provides “Cloud insurance.” If an Internet connection is not available, or if some problem disables a remote server 14 where data or files may be stored, the user 10 is able to rely upon the operating system, software applications, data, files and content stored in his or her smart phone.

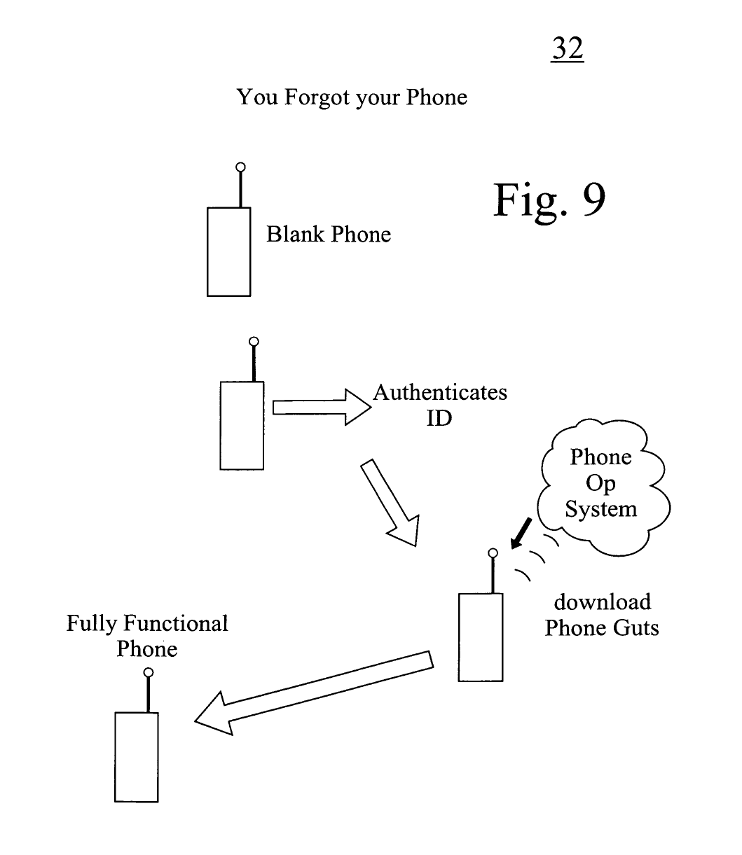

FIG. 9 offers a view 32 of another embodiment of the invention, which supplies a method for replacing a lost or stolen smart phone. In one embodiment of the invention, the replacement device may already carry the operating system, software applications, data, files, content and information that were stored on the lost device.

In one embodiment of the invention, the smart phone 12 is backed-up to one of the user's other friendly devices. The smart phone 12 may be continuously backed-up as data, files and/or content on the smart phone 12 changes. In this embodiment, a replacement for a lost or stolen smart phone 12 may be created by obtaining a new smart phone, and then downloading the back-up copy of data, files and/or content from a friendly device.

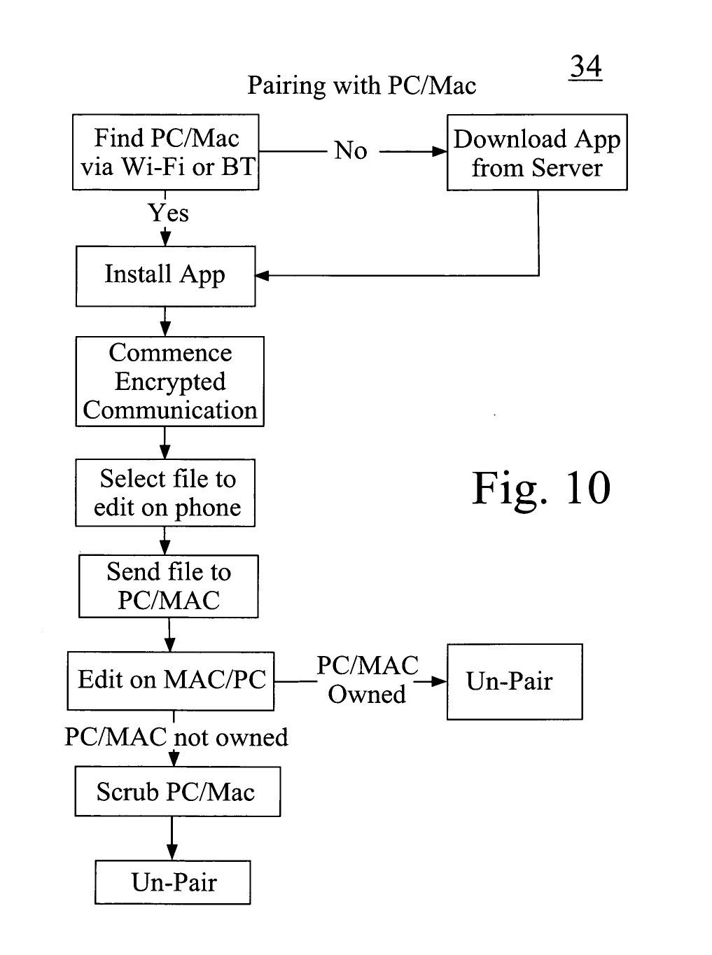

FIG. 10 is a schematic block diagram 34 which illustrates the method steps which specify one embodiment of the invention.

### III. Building a Master Library

In one embodiment of the invention, a master library is created and maintained in the user's smart phone. The master library may contain data, files, records, content, preferences, or any other information that is capable of being stored in the memory 15 of the smart phone 12.

This embodiment provides the user 10 with a convenient method of maintaining a single master library, eliminating the need for synchronizing or updating other computers or information appliances. This embodiment also eliminates the need for using remote access to a home or office computer, or to the Cloud.

In one embodiment of the invention, the master library on the user's smart phone 12 is saved each time the smart phone 12 communicates with a friendly computer or information appliance. To save bandwidth and power, only the portions of the master library which have changed since the previous update need to be recorded.

In another embodiment, the data which had been stored in a lost or stolen smart phone 12 may be easily restored on a replacement smart phone 12 by transferring a back-up copy of the Master Library from a friendly computer to the new smart phone.

The term “friendly” is used to denote a remote or separate network or device which has been “properly introduced” to the smart phone. In one embodiment of the invention, the smart phone 12 is only able to operate or control this separate network or device after an initial conversation has occurred between the smart phone 12 and the separate network or device. This initial conversation establishes the terms and conditions of the subsequent interactions, and also establishes and certifies a level of trust between the smart phone 12 and the separate network or device.

### IV. Digital Identity & Personas

In one embodiment of the invention, the total digital record or presence of an individual comprises that person's “Digital Identity.” A Digital Identity includes all a person's digital files, data, content or other information that is owned, possessed by or stored on behalf of that person. The portion of a person's Digital Identity which is available on the Internet is referred to as that individual's “Web Identity.”

In one embodiment of the invention, a Digital Identity comprises one or more “Personas.” A Persona is a segment, portion or part of a Digital Identity. A Persona is created by “partitioning” the memory 12 or other storage facility which is owned, controlled or maintained by the individual, or by another on behalf of the individual. The verb “partitioning” describes the process or method of making, forming, defining, setting, adjusting or erasing a partition or persona. Partitions may be “Dynamic Partitions” if they are capable of being altered, changed or deleted. Each partition may be further divided into “sub-partitions.”

The data, files and content stored in each partition is accessed in accordance with different access rules. As an example, access to a specific partition may require a particular password. In more complex embodiments, their may be many access rules for a partition. These access rules insure the safe access and control of all the smart phones used by each of the members of the family, and supplies an easily usable process for safe computing.

### V. An Example of Basic Uses of the Invention

Once the App 13 is downloaded to a smart phone, and after the App 13 has also been downloaded to a friendly other device, the user 10 may operate the friendly other device using the smart phone. The user 10 may control the other friendly device by utilizing the touch screen of the smart phone, by finger gestures that are interpreted by a sensor on the smart phone 12 or by using voice commands which are interpreted by software programs such as Dragon Naturally Speaking^{SM} or Siri^{SM}.

The invention allows many different users to safely and easily access and control their files, data and content. In one example, a worker may replace his or her laptop with the present invention. Since the worker has a computer at home and a computer at work, he or she may use a smart phone 12 with the App 13 instead of carrying a laptop. In another example, a student may carry all of his or her textbooks, educational materials and homework assignments on a smart phone, and then use a friendly computer at home and at school to view files, data and content.

### VI. An Example of Digital Identities & Personas for a Family

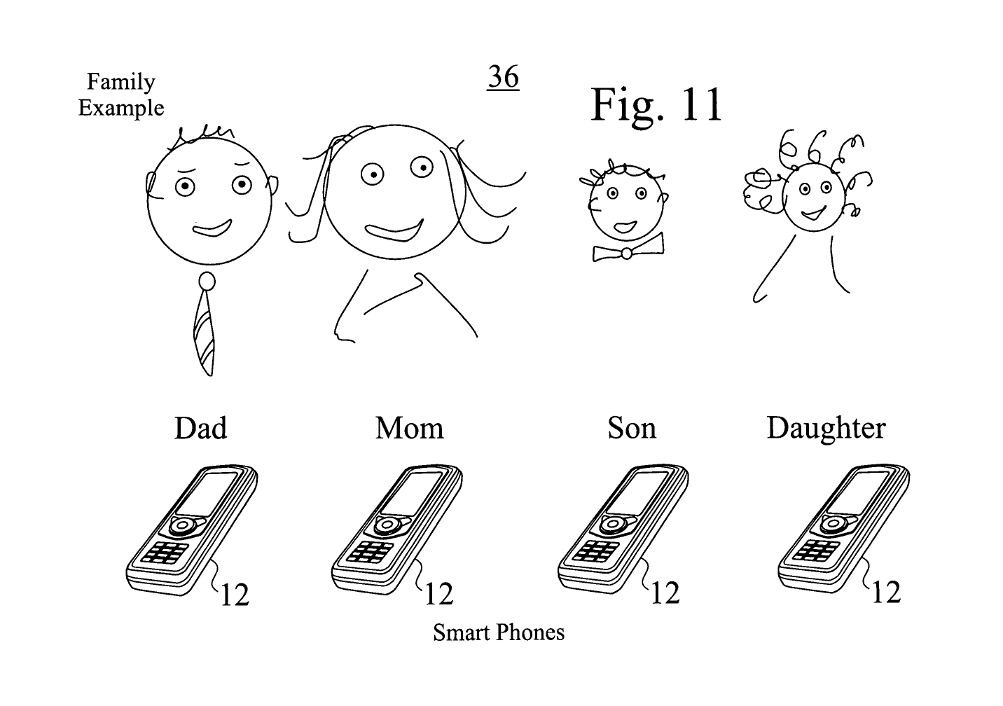

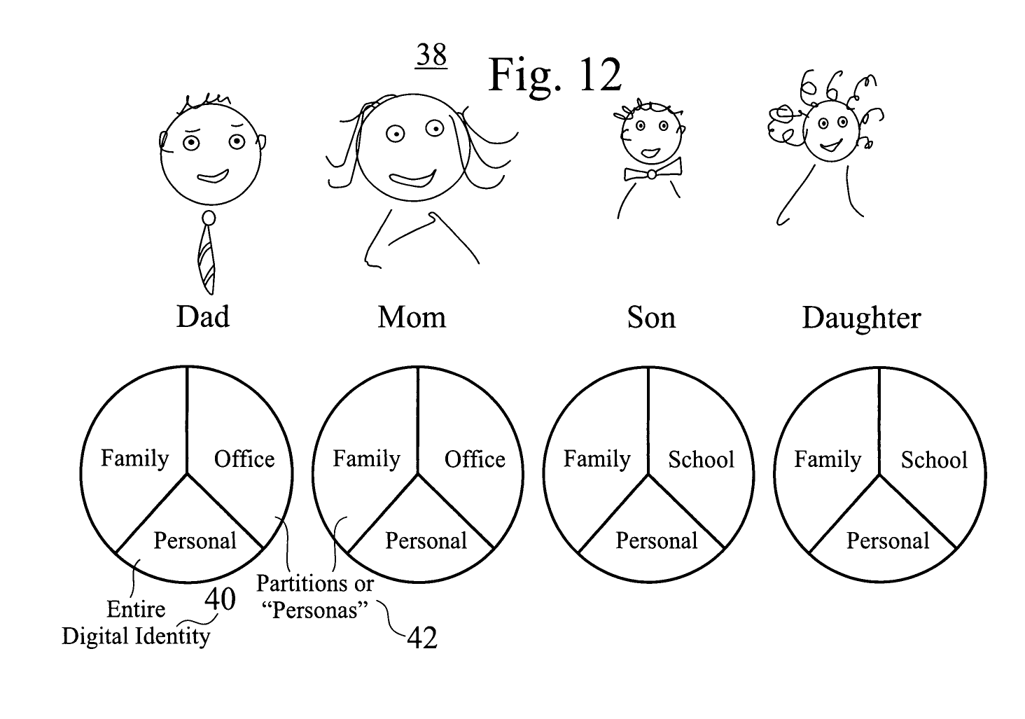

In one example, family of four each has a conventional smart phone. The present invention, the Remote Control App for Smart Phones, is downloaded and stored on each of this group of four smart phones. Each member of the family: Dad, Mom, Son and Daughter, has one of the smart phones that operates the App. This group is shown in the illustration 36 presented in FIG. 11. One of the members of the family is appointed as the Group Administrator. In this example, the Group Administrator is Dad. The Group Administrator defines, sets and names the partitions or personas for each of the four smart phones in this group. The Group Administrator has access to each of the four smart phones. The Group Administrator may have unrestricted access to every partition on every smart phone, or may have only limited or no access to some partitions, as shown in the diagram 38 shown in FIG. 12.

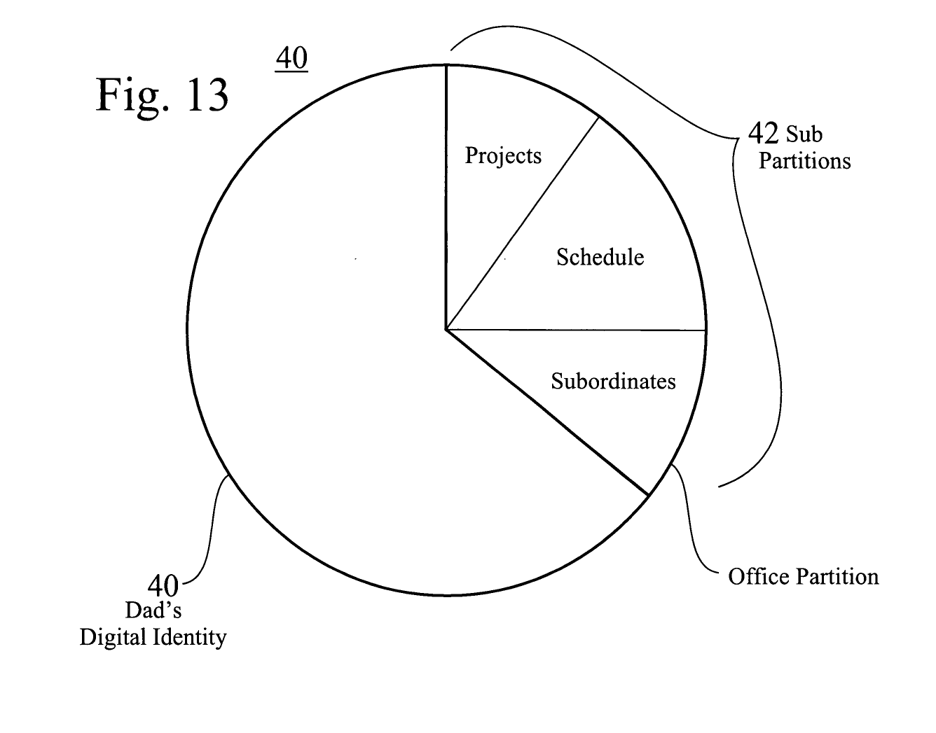

In one example, the memory 15 in each smart phone 12 in this group is divided into three partitions, as shown in the chart 40 displayed in FIG. 13, and as explained in the following table:

### Smart Phone

| Dad | Mom | Son | Daughter |
|---|---|---|---|
| Partitions | | | |
| Family | Family | Family | Family |
| Office | Office | School | School |
| Personal | Personal | Personal | Personal |

The “Family” partition includes information that is shared by all the members of this group. It may include schedules, events, birthdays, anniversaries and “to-do” lists for each individual. The “Office” and “School” partitions are reserved for information regarding Mom and Dad's jobs, and Son and Daughter's school schedule, texts, homework assignments and other education-related activities. The “Personal” partitions are maintained for information, content or files that is particular to each user 10. The Personal partitions might include links to favorite websites, subscriptions to periodicals, book, movies, videos and music.

In this example, the Group Administrator has unlimited access to the first and second partitions on each smart phone 12 in the group. The third partition on Dad and Mom's smart phone 12 may be accessed only by the owner of each smart phone. The “Personal” partitions for Son and Daughter are accessible by their respective owners, but are also limited by parental controls which excludes the download 20 of certain types of content. In this Specification, and in the Claims that follow, the term “access” pertains to the processes of reading, writing, altering, viewing, measuring, controlling, monitoring, manipulating, using, analyzing, erasing or otherwise interacting with data, content, files or information which is stored, held or present in a partition.

In this example, all of the data, files, content or other information stored on each smart phone 12 is considered to be the total and complete Digital Identity 40 for each individual. The Group Administrator may add new partitions, may vary the size of the partitions, or may delete partitions. Each individual in the group may create sub-partitions in each partition. For example, Dad's Office Partition may comprise three sub-partitions: Projects, Schedule and Subordinates. Daughter's School Partition may comprise: Courses, Schedule and Homework.

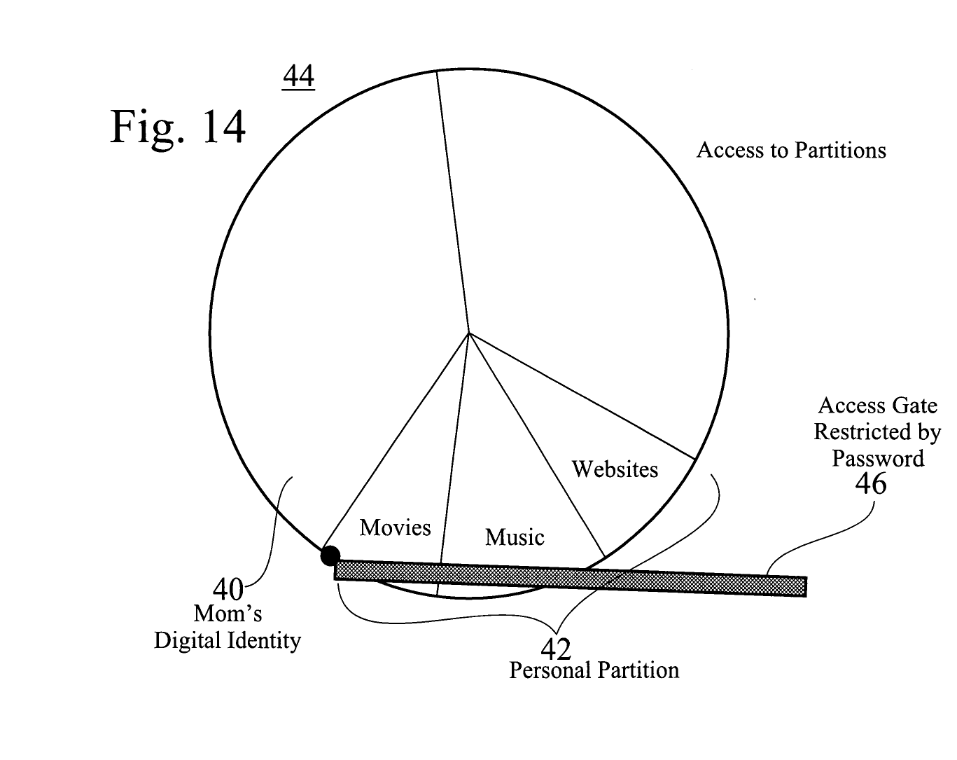

Each persona or partition 42, or sub-partition, may be governed by one or more access rules, as shown in the diagram 44 presented in FIG. 14. An access rule is a gate, protocol, principle, condition or standard 46 which governs or regulates the ability of the Group Administrator or another authorized user 10 to read, write, alter, view, measure, control, monitor, manipulate, use, analyze, erase or otherwise interact with data, content, files or information which is stored, held or present in a partition. An access rule may be considered to be a key to a lock which guards the door to each partition. As an example, access to Mom's Personal Partition requires a password known only to Mom. Many different access rules may be used as keys to partitions. An access rule may be based on the user's password, finger print, voice print, retina analysis or physical location. Other access rules may pertain to security clearances, permitted time of access, rank, office, group membership or some other affiliation or status.

### VII. A Graphical User Interface for Viewing and Managing Digital Identities & Personas in a Company

In another example, the present invention offers a graphical user interface for viewing and managing digital identities and personas in a company or organization. The term “organization” is intended to encompass any collection or group of individuals, including institutions, societies, businesses, trading partners, government agencies, military units, non-profit groups, non-commercial organizations, clubs or other affiliated parties.

The graphical user interface is generated by a software program which runs on a local or remote server. Each smart phone 12 is used to communicate with this server 14 via a wired or wireless connection.

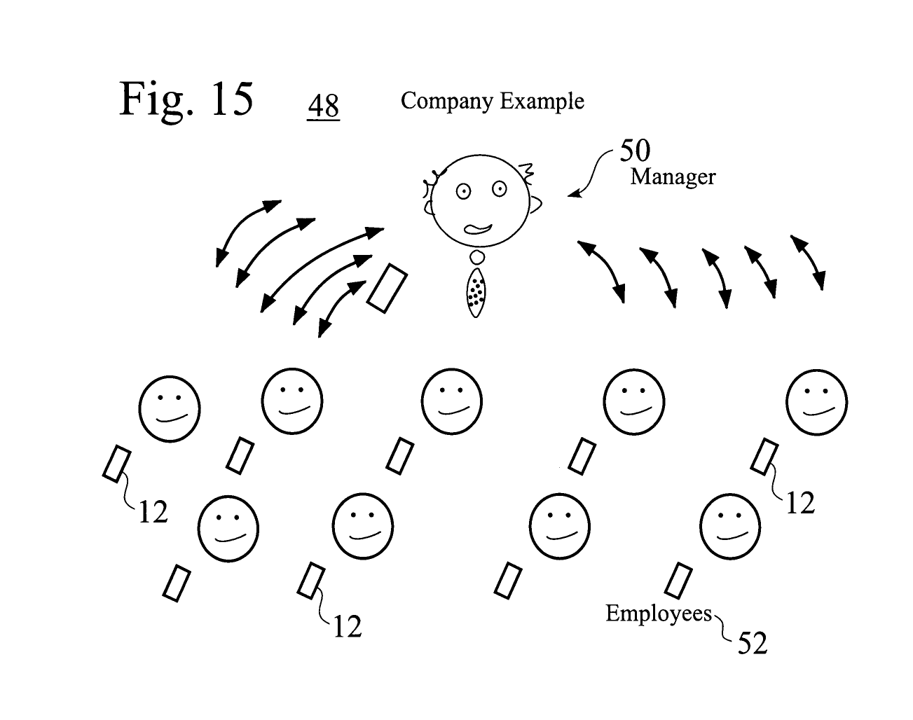

As shown in the illustration 48 contained in FIG. 15, a company comprises a Manager 50 and nine employees 52. The Manager and the employees each have a conventional smart phone 12. The present invention, the Remote Control App for Smart Phones, has been downloaded to the memory 15 in each smart phone, and changes the state of the smart phone 12 so that it provides new functions and capabilities to each user 10.

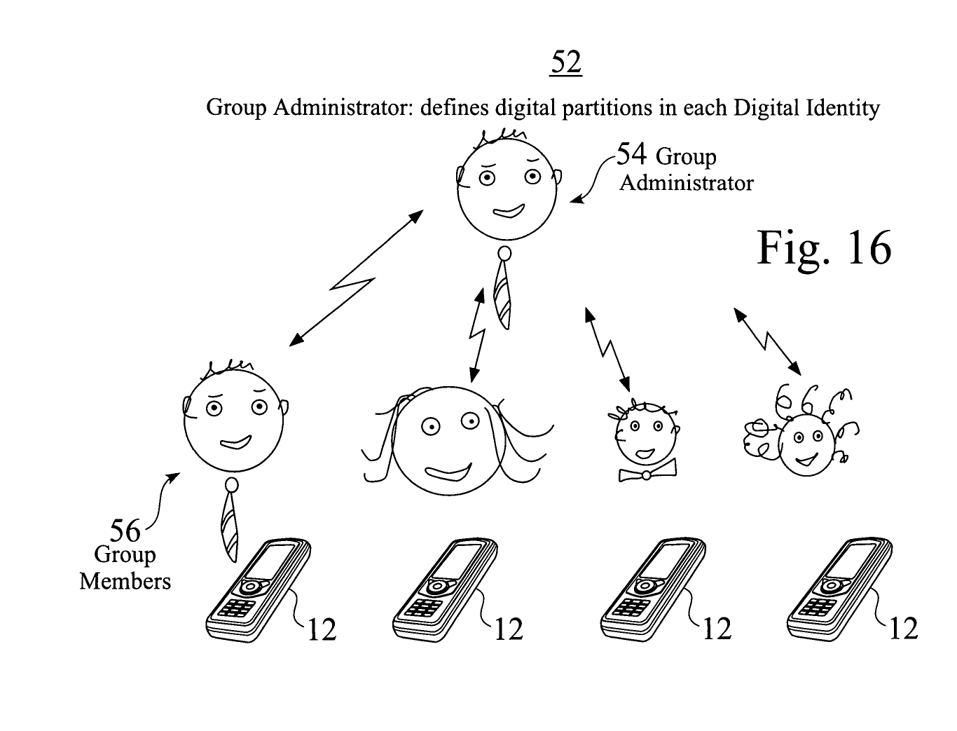

In this example, the Manager 50 is also the Company Group Administrator 54. All the operations of all the smart phones 12 in the group are based on his sole discretion and direction. The company owns all the smart phones, and all the information stored on all the smart phones. In this particular example, the Manager has the right to control and to access all the partitions of each smart phone 12 in the group, as shown in the illustration 52 in FIG. 16. In accordance with the present invention, the Company Group Administrator has the “keys” to all the partitions on all the smart phones used and operated by himself and his employees. Each employee has access to all of his or her partitions. Other employees may have access to another employees partitions, based on access rules determined by the Manager. Consultants, vendors, creditors, customers and other persons outside the organization may also be granted access to some of the partitions maintained on Company smart phones.

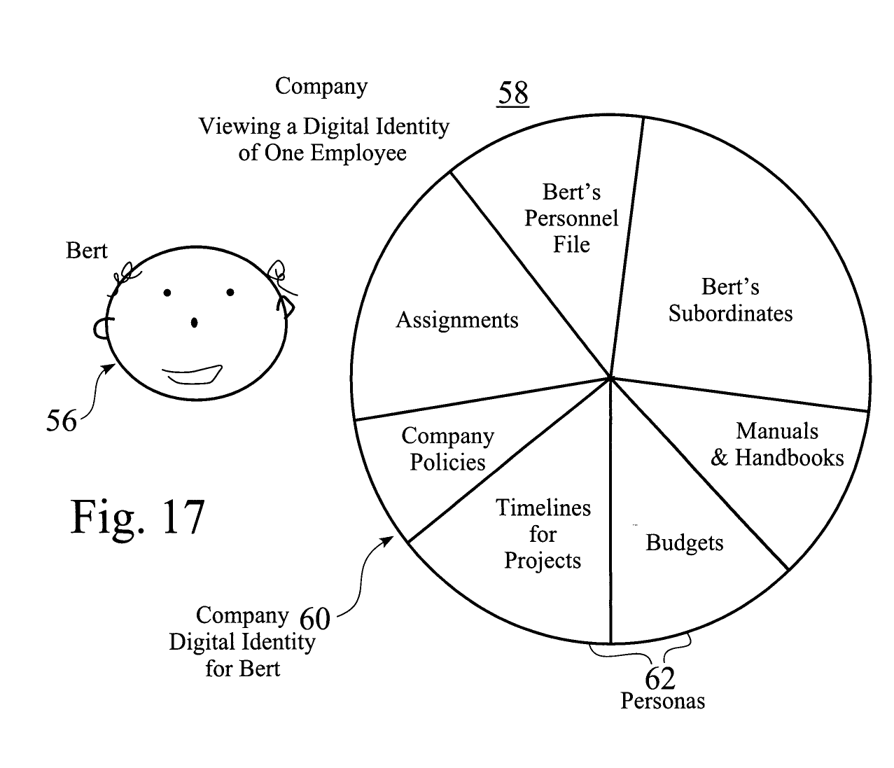

FIG. 17 provides a view 58 that shows how the Manager may easily view and interact with the different personas stored on one of the smart phones, which is used by an employee named Bert 56. Bert's digital identity as an employee is represented in FIG. 17 as a pie chart 60. Each slice in the pie chart is a company partition or persona 62. Bert may have other digital identities relating to his home, family and private life, but, in this example, his digital identity for the Company is restricted to data, files, content and information that pertains only to the business of the Company and to his duties as an employee.

Since the Manager has access to all of Bert's partitions, all of Bert's data, files, content and information that relates to the Company is always instantly available to the Manager. As an example, the Manager may enter Bert's partition for “Assignments,” and then may change tasks assigned to Bert. Bert may submit reports to the Manager simply by updating his appropriate partition. Bert's interactions with customers, suppliers, vendors and co-workers may all be logged in appropriate partitions.

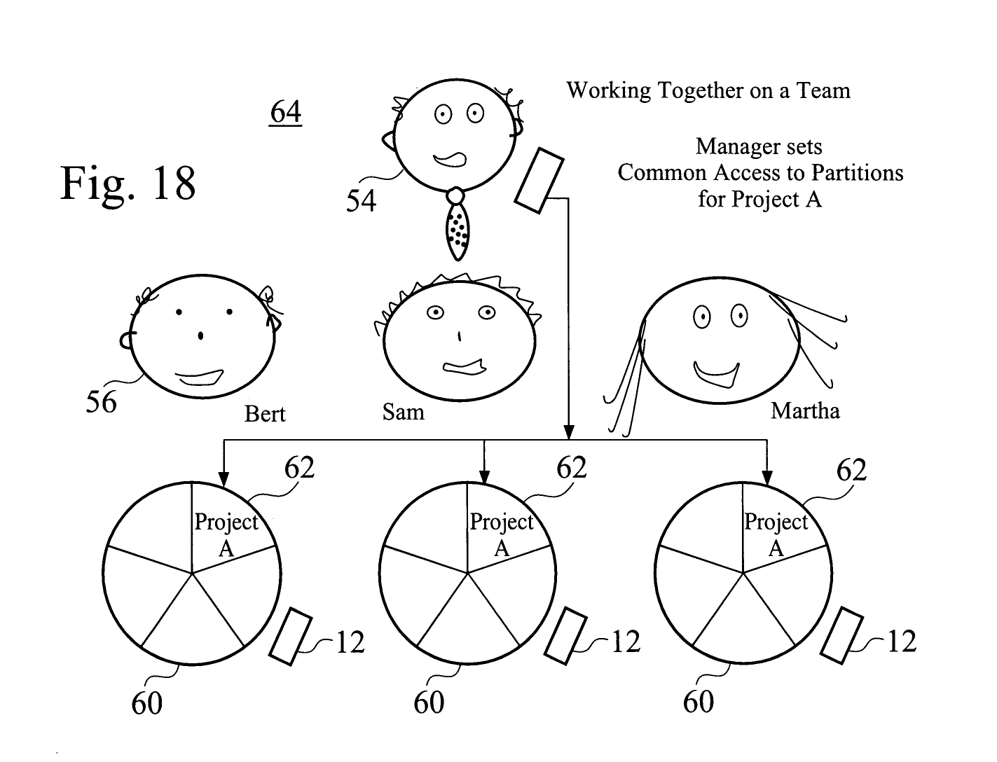

When the Manager needs Bert to work with two other employees, Sam and Martha, the Manager may link specific partitions on the smart phones operated by Bert, Sam and Martha, so that they may cooperate in a join effort, as shown in the diagram 64 supplied in FIG. 18.

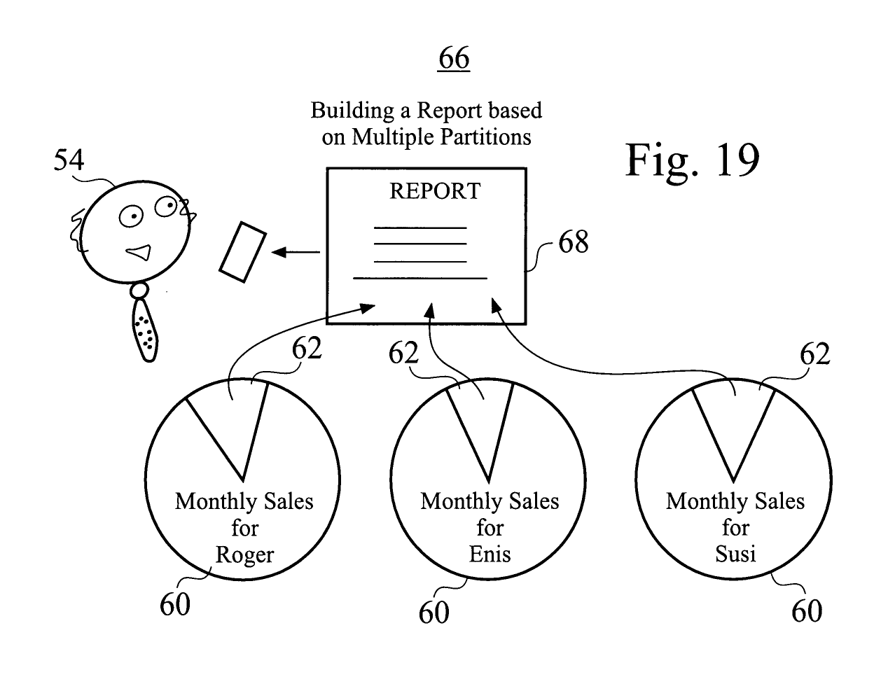

The as appointed Company Group Administrator, Manager may “drill down” through the partitions and sub-partitions of each employee to obtain information, analyze performance and to publish or to broadcast goals or requirements to each employee. As an example, each employee may have a partition named “Work Schedule” or “Travel Expenses.” The Manager may easily access all of these partitions, and may instantly process the contents of these related partitions into a spreadsheet or database to create a report for the entire Company on one of these topics. The method of generating a report 68 based on the content of multiple partitions is displayed in the illustration 66 presented in FIG. 19.

The present invention enables these methods of viewing and managing digital identities and personas because the entire digital identity of each user 10 is contained in one hardware device that is operated by each user 10. This containment of a user's digital identity in one place allows the Company's Group Administrator to easily and to effectively manage the Company's digital activities.

### VIII. Secure Communications

All communications to and/or from the smart phone 12 may be protected with security systems which thwart or eliminate fraud or misuse. A conventional product, such as RSA's PGP™, may be used. In one embodiment of the invention, a communication safeguard means is provided by the UltraSecure^{SM} System. The UltraSecure^{SM} System is described in U.S. patent application Ser. No. 09/887,570, filed on 22 Jun. 2001, and in PCT International Patent Application No. PCT/GB02/05612, filed on 11 Dec. 2002. Both of these Published patent Applications are hereby incorporated by reference.

### Bilateral and Multilateral UltraSecure

In one embodiment of the invention, the UltraSecure^{SM} System comprises a Server-side software acting as encryption for source content and a Client-side software acting as the decryption and re-assembler of the content. Two (Bilateral) or more (Multilateral) devices may be entwined with a dual asynchronous communication path wherein both the Client and Server side portions of the software are installed and registered for both devices (whether in a Ops Center or a Field/Consumer device). Such entwinement enables the use of the UltraSecure Transaction Protocol (USTP) to provide the highest level of communication, content and session security between the two devices, to fully protect data on the device, data in being transferred, data in the host, or data backups being transferred over non USTP protocol systems. Applications include secure two-way communication, remote computing and backups, network transactions (email, web, fund transfers, etc), and access to secured resources (facilities, data information, etc).

### IX. Products & Users

In an alternative embodiment, features of the invention which have been described and illustrated as hardware may be reduced to software, and provided as a web service.

The present invention may be embodied in several versions of product, including, but not limited to:

Institutional

Personal

Minor (in the family context)

Minor student

Adult student

The Institutional version may include a personal partition. This is for the convenience of the user 10, who doesn't have to carry a separate laptop. As in a corporate laptop, the institution owns the device and all of its contents, so there is no expectation of privacy in the personal partition. The user 10 may own and carry a separate smart phone 12 for his own purposes. This second, personally owned smart phone 12 may be configured by its owner so that it is not accessible by his institution. The institution's smart phone 12 is automatically backed up on the institution's server, and the personal product is backed up by the user's home device, by various means.

The present invention may also include “Dynamic Partitioning,” in which a partition may be created by the device's owner to permit access by certain individuals or classes of individuals. Among other things, this makes the current levels of clearance obsolete, since it establishes a continuum of access which may be changed by the institution to allow access on a case-by-case basis. If the user 10 is the owner, he may set up different partitions for different family members, groups of family members, colleagues, etc. These are not partitions in the sense the word is usually used, to refer to separate areas of a hard disc running, for example, different operating systems, but areas of storage and activity memory 15 which can expand and contract as needed, but which are inaccessible from other partitions in memory. These partitions are accessible by the user 10 with biometric and password identification. When he is using them, he may communicate only with permitted others who have similar identification.

The Dynamic Partitions in the Industrial model may be installed remotely by the person calling a meeting, session or establishing a project; or by the supervisor of a work group or department. In one example, he would request his server 14 to set up partitions for Tom, Dick and Harry on their devices for a period of time, to inform them of the time of the meeting, or the existence of the project and provide them with passwords for that partition. The password distribution would be through an encrypted link such as UltraSecure, and would be available only to the particular user.

This is an automatic process performed by the server, which would automatically remove the partition when it is no longer useful. From the users' points of view, someone called a meeting or established a project and gave them the passwords to access it. Other than the simple process of placing an order on the server, the whole process requires no human intervention. The partition is made out of “rubber,” and expands and contracts to fit the data contained therein. When the transaction or project is over, it disappears along with its contents.

As an example, an institutional customer may provide smart phones to employees. The institution or each employee would create his or her own Dynamic Partitions, eliminating the need for each employee to move company files to other computers. Each partition would, for example, have different rules about printing and file transfer, along with the other constraints and controls, such as biometric and unique-to-the-partition password access.

Dynamic Partitioning may be supported via meta data logic (including search logic) that brings up a side bar. This side bar would suggest access to various partitions and the files stored within them, such as, project alpha, boy scout troop, personal finance, my medical record, etc.

### X. Additional Embodiments of the Invention

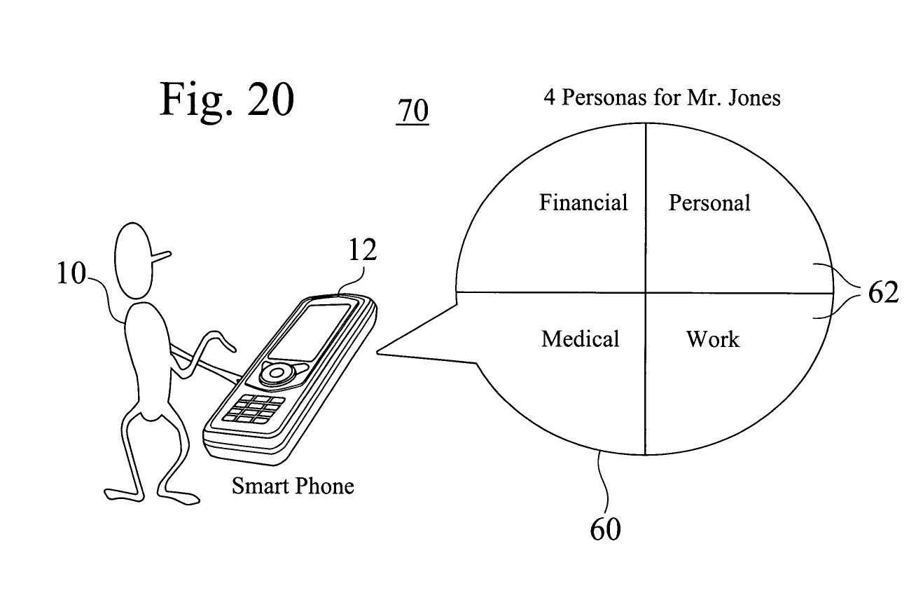

FIG. 20 offers an illustration 70 which shows how a smart phone 12 can be programmed by its user, Mr. Jones, to include four Personas: Financial, Personal, Medical and Work. Data pertaining to each of these Personas may be stored on the smart phone, on a remote server, or both.

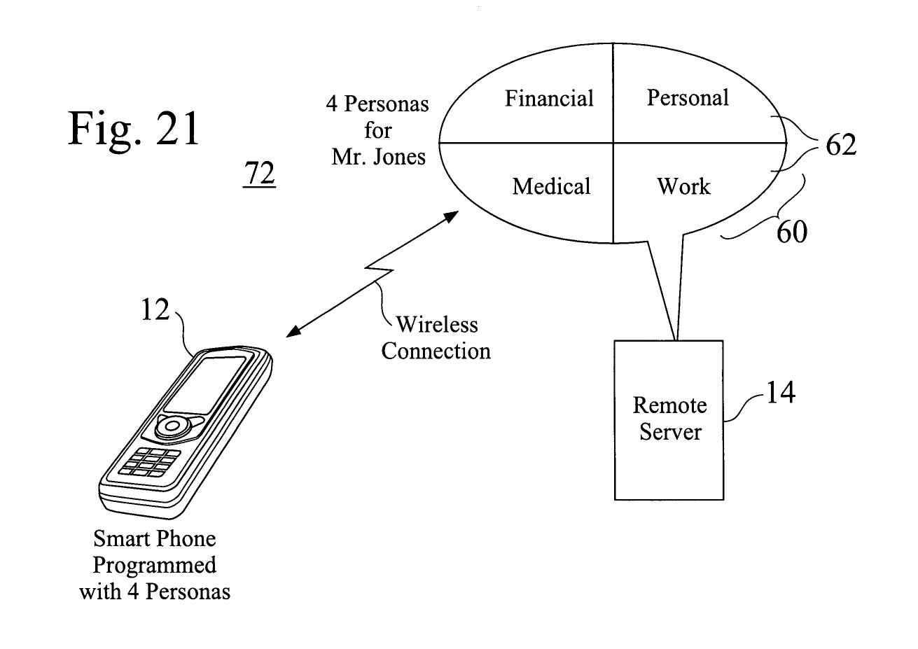

FIG. 21 is a depiction 72 that shows that Mr. Jones' Four Personas may be stored in the Cloud, which could be accessed by other devices with the proper authorization.

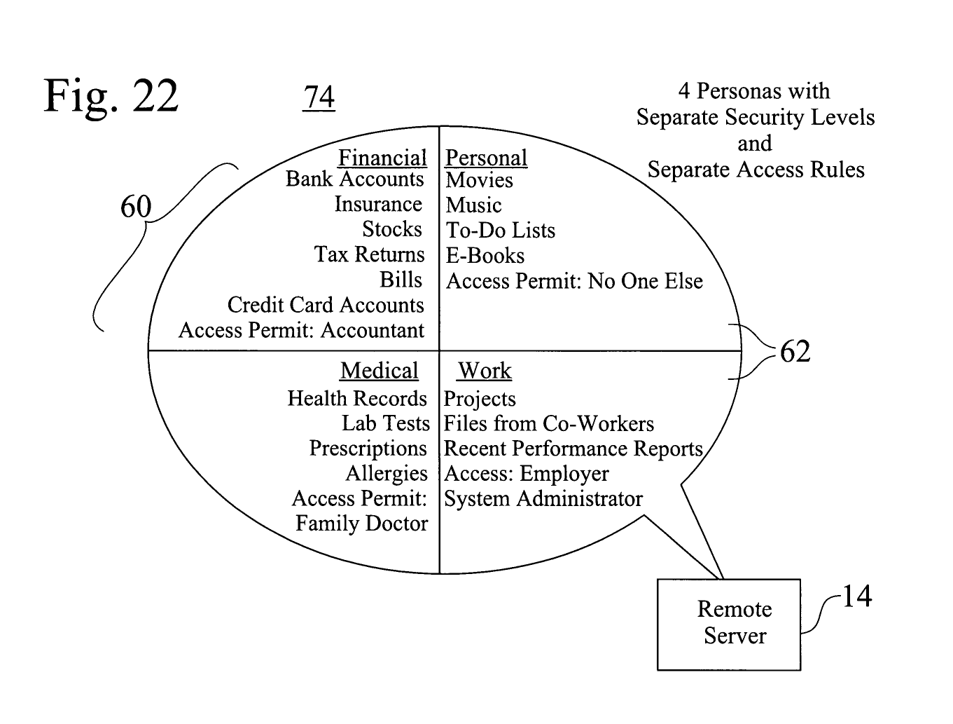

FIG. 22 reveals a diagram 74 that shows details of the information within each of the Four Personas. Each Persona may have a different level of security, and may be programmed with rules for access by other persons.

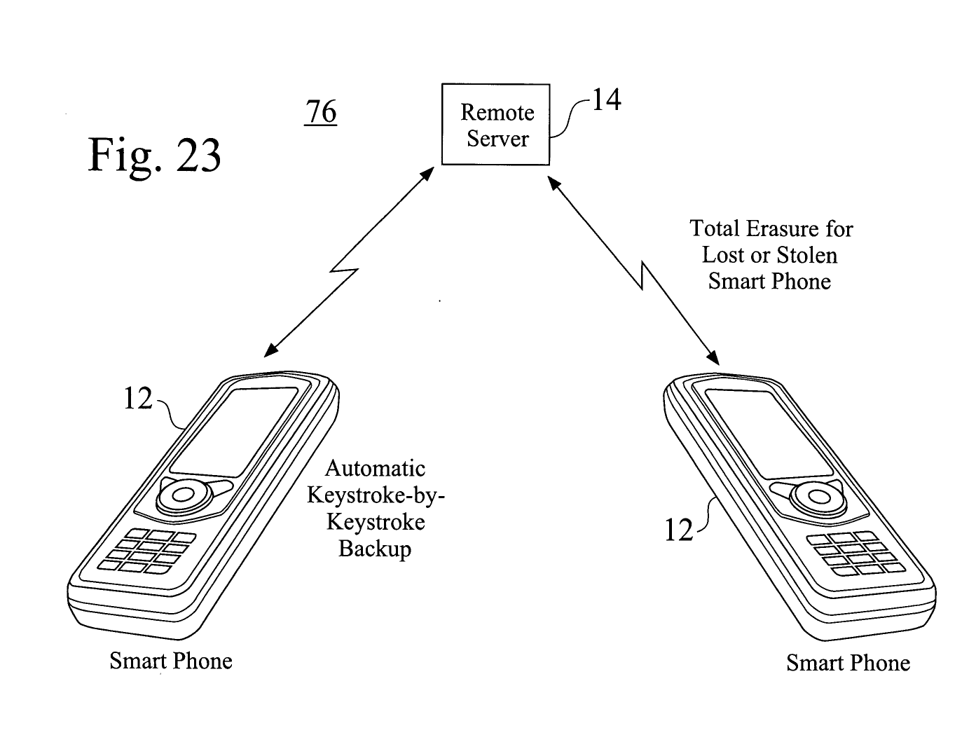

FIG. 23 is a portrayal 76 of two additional features: Inputs to Mr. Jones' smart phone 12 may be backed up automatically, keystroke-by-keystroke, to a remote server. Also, if the smart phone is lost or stolen, Mr. Jones can call a telephone number, and, by entering a special code, instruct the remote server 14 to permanently erase all the data in his smart phone.

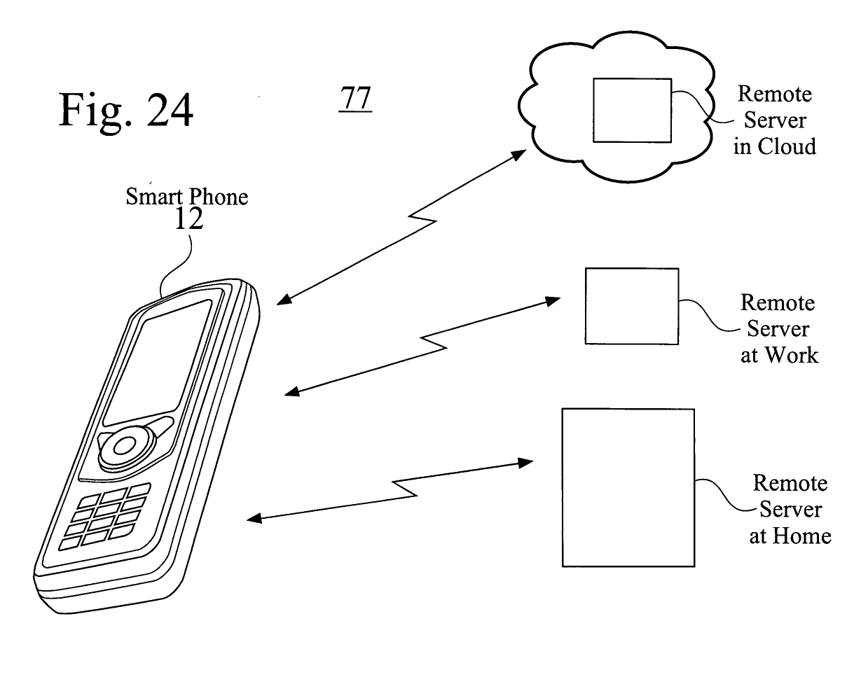

FIG. 24 is a diagram 77 that the data in Mr. Jones smart phone 12 may also be stored in a remote server 14 in the Cloud; in a server 14 at work; or in a PC at home.

### XI. After-Mark Security Enhancements

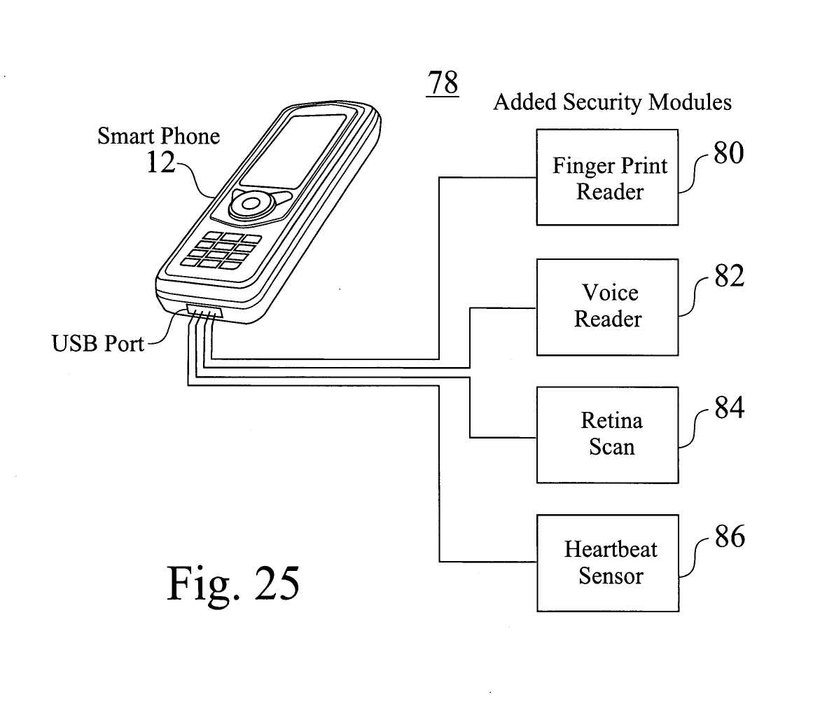

FIG. 25 is a schematic diagram 78 that shows after-market security modules which may be connected to the smart phone 12 to enhance its security. These devices may include, but are not limited to, a finger print reader 80, a voice reader 82, a retina scanner 84 and/or a heart beat sensor 86.

### XII. UltraSecure Protection

### Summary

This embodiment of the present invention supplies a means of copy protection for digital content. In one embodiment of the invention, all responsibility for copy protection has been removed from the user's player or terminal. All the security features are removed from the player, and placed in a secure “box.” The box incorporates security protocols that use strong cryptographic algorithms as primitives to insure that the security furnished by the module cannot be broken.

In one embodiment, a delivery source or station sends the bounded-time computational ability to display the content separately from the digital content, and then self-destructs. The division of labor between station and box means that unusually strong encryption algorithms may be employed, and while keeping the cost of manufacture of the box low since they require relatively little processing power. When the box is purchased, a registration process enters a security protocol.

The present invention offers a distributed end-to-end system/security architecture that is completely independent of the communications media which is employed. The present invention may be utilized to secure or protect any digital content, including high value files that contain movies or music which are transported over a network, or which are stored on a physical medium such as a DVD or CD.

### DRAWINGS

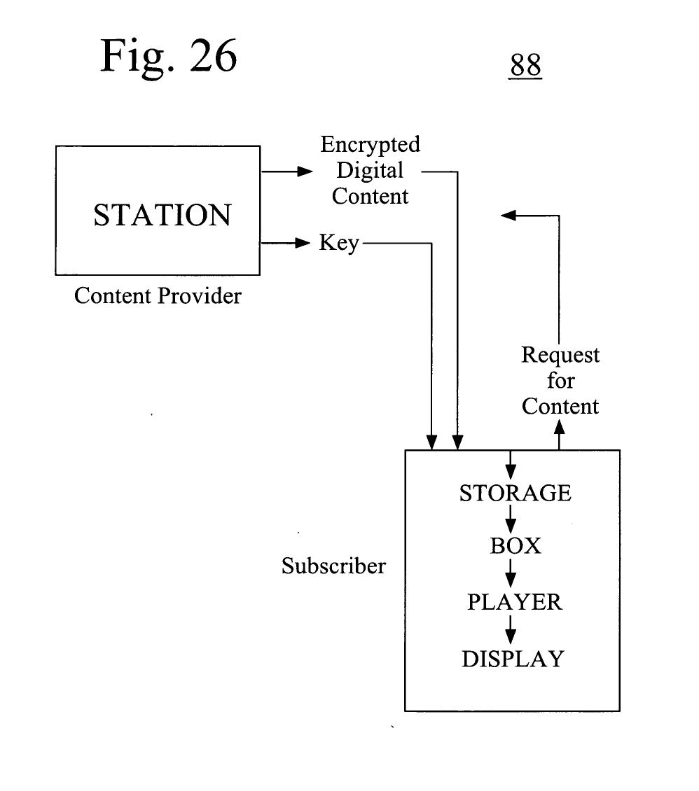

FIG. 26 is a schematic diagram 88 of a method and apparatus for the secure delivery of digital content.

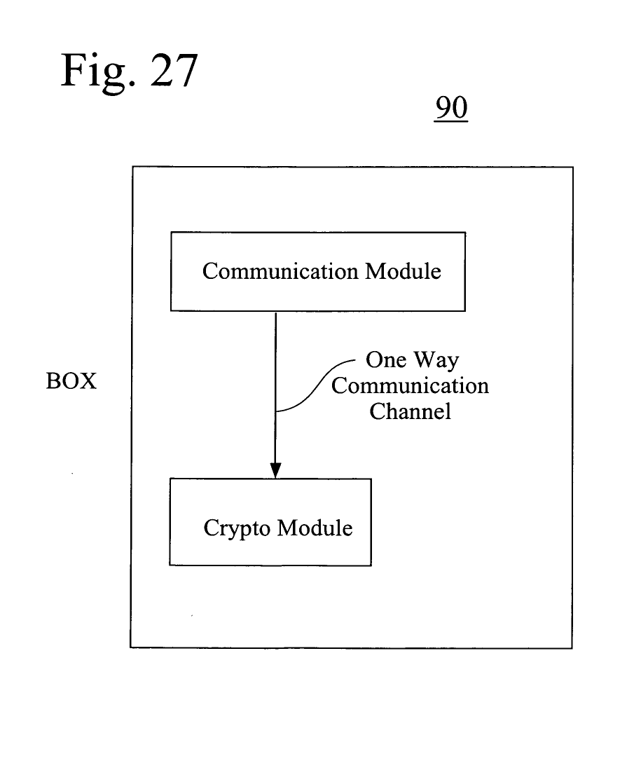

FIG. 27 is a schematic diagram 90 of additional details of the method and apparatus shown in FIG. 26.

### DETAILED DESCRIPTION OF ULTRASECURE EMBODIMENT

### Overview of the Invention

One embodiment of the invention comprises a method for copy protection for the owner of digital content that is displayed on a user's player or terminal. The responsibility for copy protection is removed from the player, and is placed inside an appliance or terminal in a secure “box.”

In a preferred embodiment of the invention, cryptographic primitives (encryption algorithms, message-authentication codes, hash functions, random-number generators, etc.) are used in a novel security protocol together with a novel key exchange protocol. The invention may be utilized to protect a first-run movie that has been digitized in accordance with one of the current or forthcoming standards (e.g., MPEG). Content receivers or users first register their boxes. This registration information is stored in a secure database. When a subscriber registers, he then receives a box (interface to his player) that has been initialized to contain a number of tamper-proof secrets that are shared between the station and that particular box. The station stores an encrypted version of the digital content. This encrypted version ultimately arrives at some unprotected storage medium local to the player. Upon demand, the station delivers to the box the use-once computational ability to decrypt the content and display it on the player or terminal.

The box is configured for a computational workload that allows them to be manufactured relatively cheaply. The station is configured for a computational workload that allows it to keep pace with what might be one million simultaneous requests for service from one million boxes. In one embodiment, the box is a modest-sized information appliance, while a station comprises a cluster of workstations (or equivalent) as the number of boxes per station grows. Initial encryption of the digital content and security-domain initialization of station and box both count as precomputation.

The encrypted content or ciphertext is stored on some removable or fixed storage medium within the user's player. The subscriber then requests the content provider to supply a “key” which enables the box to play or the content. This request will may require a payment from the subscriber to the content provider. Once the content provider is paid, or approval to decrypt the content stored in the user's box is granted, the station supplies the transient computational ability to display the content once. The word “transient” is used here because the computational ability self-destructs as it is used. The subscriber may issue as many requests for use-once computational ability to display this movie as he desires; this resembles “pay per view” with higher-value digital content. The invention may employ multiple time sensitive keys which vanish as soon as they are used.

The present invention may be utilized to secure or protect any digital content, including high value files that contain movies or music which are transported over a network, or which are stored on a physical medium such as a DVD or CD.

One embodiment of the invention includes:
encrypting digital content;
establishing a priori shared secrets between a station and a box by tamper-proof burning of secret information into boxes prior to their registration;
creating a security protocol to deliver the transient computational ability to a given box to display the encrypted digital content precisely once (this ability self-destructs as it is used); and
designing the box system architecture, with particular attention paid to physical-security issues (the box's physical-security perimeter must be implemented by hardware means within the box).

### Encryption

Before the subscriber can obtain content, such as a copy of an encrypted digital film, it must first have been encrypted. This encryption must offer extremely high-assurance confidentiality, and be susceptible of decryption by equipment used by the subscriber. In one embodiment of the invention, an appropriate strong encryption algorithm is selected. For encryption of large files containing high-value digital content, a choice must be made among various methods, including symmetric-key, asymmetric-key and public-key cryptography. The throughput rates for the most popular public-key encryption methods are several orders of magnitude slower than the best-known symmetric-key schemes. All operational systems use a hybrid approach that utilize both kinds of cryptography. Specifically, public-key schemes are used only for cryptographic-key exchange, while the more efficient private-key schemes are used for actual encryption and decryption of digital content. In one embodiment of the invention, no cryptographic keys are ever public per se; at most, some of them are published in a secure fashion within an individual security group. Symmetric-key methods can be quite strong.

In one embodiment of the invention, the symbol “M” is used to represent a file containing a first-run movie that has been digitized according to some MPEG standard. In this particular instance, the MPEG standard also defines the decryption throughput that must be achieved by the box in order that the decrypted signal may be injected into the subscriber's player or terminal at the expected rate. (This example assumes on-the-fly decryption).

File M is divided into ‘s’ fixed-size segments, where ‘s’ is chosen by the security architect. Segments are portions of a file, such as a movie. By increasing the value of ‘s’, the amount of plaintext that is encrypted can be limited by any one cryptographic key. The trade-off here is between unusually high degrees of assurance, and the number of keys that must be exchanged between station and box during one key-exchange protocol. The present invention has been designed with any number of parameters so that security may be increased. In general, when the level of security is increased, the performance decreases. The majority of the key-exchange work is borne by the station, and is, therefore, limited only by computing power of the station.

At this point in the process, file M is a sequence of plaintext segments <b_j>, 1<=j<=s. Each film segment b_j is encrypted using the Rijndael symmetric-key encryption algorithm, which is the new Federal Advanced Encryption Standard (AES). Rijndael is superior to the unclassified symmetric-key algorithms it replaces in both security and performance. In one embodiment, both the block length and the key length are chosen to be 256 bits.

Since Rijndael is a block cipher, and since it is unlikely that the length of a film segment b_j is less than or equal to 256 bits, Rijndael must be combined with an appropriate cipher-block chaining strategy such as Cipher Block Chaining (CBC). Several choices are available. A different 256-bit Rijndael key k_j is used to encrypt each film segment b_j, 1<=j<=s. The ciphertext corresponding to b_j is denoted c_j. The division into segments increases the strength of the encryption, by encrypting less plaintext with a given key, and also provides great flexibility in the decoding strategy.

No special care is required in selecting Rijndael keys. In one embodiment of the invention, keys are selected using a method that prevents a hacker from breaking the security of the system. A random-number generator or other mechanism may be employed, as long as the keys are generally unpredictable and irreproducible. In one embodiment, the 256-bit keys are genuinely random numbers produced by physical processes such as electrically noisy diodes. Genuinely random numbers are used as Rijndael keys, not to make Rijndael run better, nor to prevent a hacker from breaking the security of the system, but, rather, to open up entirely new key-exchange and/or key-determination possibilities.

After encryption, the encrypted-film file M′=<c_j>, 1<=j<=s, and the film-segment-key file K=<k_j>, 1<=j<=s. Both encrypted-film file M′ and film-segment-key file K are stored securely in the station. The plaintext file M is no longer required.

### Registration & Initialization

The second component concerns the initialization of both station A and box B where there is one station A and many boxes B. Some station initialization is done once for all boxes in the security domain, and some is done on a per-box basis. Box initialization becomes “valid” as soon as the box has been registered with the security domain.

1) A box-independent public-key cryptosystem is constructed for station A based on the RSA™ cryptosystem, but using quasi-public keys. The symbols ‘p’ and ‘q’ are employed to denote two large distinct primes. The symbol n=p*q. The set of plaintexts and the set of ciphertexts are both equal to the finite ring Z_n. Any message too long to belong to Z_n is dealt with by Cipher Block Chaining (CBC). Two exponents ‘e’ and ‘d’ are constructed such that exponentiation by one exponent modulo n is the inverse of exponentiation by the other exponent modulo n. One exponent, ‘pubA’, chosen small, is burned into each box registered with this station, along with the modulus In′. The other exponent, ‘priA’, which may be large, is a secret of station A. The key ‘pubA’ is a quasi-public key that is burned into each box B registered with A in a tamper-proof way so that ‘pubA’ is not recoverable from box B. The same holds true for modulus In′.

Any box B will raise numbers to the power ‘pubA’ modulo n to encrypt messages intended for station A and to verify digital signatures generated by station A. This is sufficient for a rapid authentication protocol that authenticates a given box B to station A provided that each box B is given a large, (for example, 256-bit) genuinely random string ‘idB’, which is a shared secret between A and B, that is a unique identifier for a given box B among all boxes registered with that station.

2) A box-independent large cyclic group is then constructed, in which the discrete-logarithm problem is intractable for station A. This can be done either with standard number theory or elliptic-curve techniques. One method that may be employed is to choose a large prime ‘p’, and then to use the multiplicative group of integers modulo p, i.e., Z*_p, as the cyclic group. Since ‘p’ is a prime number, there will be many primitive elements ‘x’ such that raising ‘x’ to successive powers will generate all the elements of the cyclic group. A primitive element modulo p has the same order as the cyclic group Z*_p, viz., p−1.

This additional machinery, on top of station A's long-lasting public-key cryptosystem, is used in the key-exchange protocol to generate session keys for encrypting the file-segment keys k_j, 1<=j<=s.

As an example, an appropriate prime ‘p’ and generator ‘alpha’ of Z*−p (2<=alpha<=p−2) is selected. Quasi-ElGamal key agreement may be achieved between station A and each one of one million boxes B as follows. For a given box B, A would normally need to reliably know the public key (p, alpha, alphâb) of B. In this example, station A has a cyclic group whose order is at least one million. Station A randomly and uniformly picks a distinct exponent ‘b’ 1<=b<=p−2, for each of the one million boxes it registers. Station A secretly computes and stores alphâb, for each box. As part of the registration process, exponent ‘b’ and prime ‘p’ are burned into the given box B (with a different ‘b’ for each distinct box B). When station A wishes to share a session key with a given box B, it randomly and uniformly picks an integer ‘x’ from the same range, and computes and transmits alphâx, called “elementA”, to box B. Station A computes (alphâb)̂x modulo p as the shared secret key, while box B computes elementÂb modulo p as the key, where, by construction, the keys are the same.

Considering just the first two components, after registration, a given box B must securely store:

1) the small integer ‘pubA’, which is station A's quasi-public key:
2) the RSA modulus In′;
3) the 256-bit quantity ‘idB’ that uniquely identifies the given box B;
4) the 20-bit quantity ‘bB’, which probably should not be a small integer even though the adversary has no knowledge of prime ‘p’; and
5) the prime ‘p’ that is the modulus for the cyclic group Z*−p.

### Box System Architecture

In one embodiment of the invention, Box B comprises two distinct modules with an extremely narrow interface. The first module is a communications module, which may comprise a communications processor, a simplified file-transfer protocol, and a local disk. As a simpler alternative, the communications module may comprise a slot into which an encrypted DVD can be inserted along with a DVD reader. The second module is a crypto module that is responsible for the key-exchange protocol, and for the decryption of the encrypted digital content. The interface between the two modules is a one-way communications channel which enables the communications module to transmit the encrypted bitstream to the crypto module.

### The Physical Security of the Player

In one embodiment of the invention, the crypto module, which includes the key-exchange module and the decryption module, is provided with exceptional physical security. The crypto module is designed to be tamper-proof in a fail-safe way. Faraday cages may be used to eliminate leakage of van Eck radiation. Volatile storage, together with “erase on tamper,” must delete all keying information upon tampering with extremely high assurance. Finally, all microelectronics and wires are coated with Superglue™ which destroys the underlying circuitry if they are removed or disturbed.

The tap-proof line that runs out of the decryption module is also protected. Various anti-wiretapping strategies, including the use of piezoelectric materials, are employed used to signal the crypto module to “wipe clean.”

In one embodiment of the invention, the key-exchange module can deliver the file-segment keys k_j to the decryption module as plaintext. An alternative method employs the delivery of the Rijndael-encrypted k_j, along with their keys kk_j. The decryption module would then perform successive Rijndael decryptions to recover first the k_j and-then-the digital content.

Some of the properties of the box that is utilized in one embodiment of the invention are summarized below:

1) The communications module employs any communications medium to obtain the encrypted film: over the Internet, captured from a direct satellite broadcast, read in from a CD-ROM, etc. The encrypted file is stored on disk or some storage medium nearby.
2) The crypto module has the following features:
a) ‘idB’ and ‘pubA stored in box B allow cheap secure authentication of B to A
b) ‘bB’ stored in box B allows computation of the session key ‘S’ used to encrypt/decrypt the ‘s’ film-segment keys k_j 1<=j<=s. The computation by box B is S=elementÂbB modulo p, where ‘elementA’ is transmitted in plaintext from A to B, and “bB’ and “p” are secrets of box B.

The station must deliver ‘s’ 256-bit keys k_j to the requesting box, which is 256*s bits altogether. But each of the k_j was chosen as a genuinely random number using some random physical process. It follows that the concatenation of all the keys k_j in ascending order is a plaintext of length 256*s bits with no redundancy whatsoever, unlike what would be expected if the plaintext were a human-comprehensible message expressed in a natural language such as English.

As their name indicates, one-time pads are never supposed to be used more than once because that would allow an adversary to exploit the redundancy of the underlying plaintext. Transmission of perfectly random plaintext allows the invention to realize efficiencies that are forbidden to ordinary plaintext.

Station A and a given box B have a fixed shared secret (the 256-bit quantity that uniquely identifies box B), and a variable shared secret which changes with every invocation of the key-exchange protocol by box B. In one embodiment, the variable shared secret is 20 bits long, but this could be bootstrapped (if necessary, by iteration) to become a longer shared secret.

Either the fixed shared secret or the variable shared secret (or some combination of the two) could be used as a one-time pad to encrypt the random plaintext along one-time-pad lines, in which both encryption and decryption are simple “exclusive or.”

In the remainder of this Specification, the 256-bit session key shall by used to perform a Rijndael encryption of the random plaintext constituted by the ‘s’ k_j.

3) ‘idB’ and ‘pubA’ (stored in permanent storage) lead to the construction of a session key ‘S’ for this one-time provision of the (self-destructive) computational ability of B to allow the player to display the film.
4) Session key IS' allows the IS' film-segment keys k_j 1<=j<=s, to be built up in temporary storage. They are encrypted and decrypted with session key ‘S’, using Rijndael. Since k_j at 256 bits is much smaller than a film segment, it may be possible to use a Rijndael key that is somewhat smaller than 256 bits. If Rijndael is used for both keys and film, both the key-exchange module and the decryption module can call on the same Rijndael decryptor submodule.
5) “Tamper proof” means that both temporary and permanent storage will be wiped clean if anyone attempts to open the crypto module. Superglue™ piezoelectric techniques, and physical construction together provide layered “titanium-box” physical-security to the key-like material stored in box B.

### Key-Exchange Protocol

A brief description of the key-exchange protocol, where A is the station and B is one of one million boxes registered with the station, is provided below. Standard notation is used. A and B are legitimate parties.

“A-->B: x” denotes the message x sent by A to B. Spoofing is possible so that B does not normally know if the message was indeed from A.
“1. A-->B: x” denotes that which the protocol designer intended as the first message of the protocol. The trustworthiness of the external world cannot be assumed so this too must be independently verified.
“{x}k” means x encrypted under k.
“[x]k̂−1” means x signed under k̂−1 the key that “inverts” k.
This notation recognizes that the key pairs used in cryptosystems come in pairs, where one key allows encryption and the other key (the same key in symmetric-key systems) allows decryption. The private decryption key is used to generate digital signatures.

### DESCRIPTION

Each key-exchange protocol step is followed by a description in simple English.
1. B-->A: {Step 1 (B to A), movie, idB, numberB, MAC}pubA
Box B initiates one instance of the key-exchange protocol with Station A by sending him this message. Box B identifies the protocol step, the movie, and provides his genuinely-random 256-bit unique identification number ‘idB’.
‘NumberB’ is the number of times this box has initiated this key-exchange protocol. ‘MAC’ is a message-authentication code implemented by a keyed hash function. The file is encrypted with station A's quasi-public key ‘pubA’. ‘NumberB’ will be incremented by one before this protocol is invoked by box B again.
2. A-->B: <Step 2 (A to B), elementA, numberB, MAC>
This message is sent in the clear with integrity and authentication checks. In particular, the message-authentication code (MAC) is [h(m)]priA, i.e., the hash of the entire message preceding the MAC digitally signed by station A. ‘NumberB’ could be camouflaged if this is desired. ‘ElementA’ is randomly selected by station A as an element of the large cyclic group managed by A. When box B receives this message, it is either discarded or else allows box B to compute the session key S=elementÂbB. At this point, both station A and box B share the secret session key ‘S’, which is unavailable to anyone else even though ‘elementA’ was sent in the clear.
3. B-->A: {Step 3 (B to A), ack}S
Box B acknowledges successful computation of session key ‘S’.
4. A-->B: {Step 4 (A to B), segment size, s}S
The station provides some information about the file.

### 5. A-->B: {Step 5 (A to B), j,

k_j}S, for 1<=j<=s.
The station transmits all ‘s’ film-segment keys k_j to box B. Individual keys may be sent as separate messages or all keys may be sent as one long message. The conservative approach is to use a suitably-sized ‘S’ as a Rijndael key and encrypt each k_j, or the concatenation of all k_j, with the Rijndael algorithm.
6. B-->A: {Step 6 (B to A), ack}S
Box B acknowledges successful termination of this instance of the key-exchange protocol. Upon recovery of all the fragment keys k_j, session key ‘S’ is destroyed.

### Decryption of Digital Content

Box B has access to ‘s’ encrypted film-segments c_j, 1<=j<=s. He also has access (possibly all at once, possibly just in time) to ‘s’ Rijndael symmetric-key decryption keys k_j, 1<=j<=s. There is great flexibility at this point. Depending on the ability to buffer within the decryption module, the segments may be decrypted in sequential order, in some other order, or even in parallel.

In the simplest case, the fragments will be decoded r and sent in order to the player by secure cable. There is a clear division in time. When the box is freestanding from the player, the invention guards the plaintext MPEG signal up until it enters the player through the digital input port. As soon as key k_j is used to decrypt segment c_j, k_j is destroyed.

### Installation & Security of the Box

In one embodiment of the invention, the a customized cable is used to connect the crypto module to the subscriber's player. The box may be embedded inside the player. Any tampering with the cable or the connection to the digital input port causes a shutdown of the entire crypto module, and the erasure of all permanent and temporary storage within the crypto module. A description of other features of the box follows:

1) In permanent box storage, ‘idB’ and ‘bB’ must be protected with extreme care, i.e., the tamper-proof “titanium box” must guarantee that these two bit values cannot be captured even if the box is physically attacked.
2) The fragment keys k_j, 1<=k_j<=s, must be protected. Their physical presence inside the crypto module is relatively brief. The session key ‘S’ is also quite sensitive. It can be used after the fact to recover the k_j.
3) It may be preferable to use distinct session keys to encrypt distinct segment keys. This could improve flexibility and efficiency, as well as increase security.

### Applications in Gaming & Banking Environments

One embodiment of the present invention may be utilized in the gaming industry to manage gaming equipment. Some applications of this embodiment include the secure collection of data, maintaining gambling transactions, and distributing executable software files.

A second embodiment of the present invention may be utilized in the banking industry to secure and to manage transactions.

### SCOPE OF THE CLAIMS

Although the present invention has been described in detail with reference to one or more preferred embodiments, persons possessing ordinary skill in the art to which this invention pertains will appreciate that various modifications and enhancements may be made without departing from the spirit and scope of the Claims that follow. The various alternatives for providing a Remote Control App for Smart Phones that have been disclosed above are intended to educate the reader about preferred embodiments of the invention, and are not intended to constrain the limits of the invention or the scope of Claims.

### LIST OF REFERENCE CHARACTERS

10 User
12 Smart phone
13 App
14 Server
15A Smart phone non-volatile memory
15B CPU
15C Volatile memory
15D Long range radio
15E Long range radio antenna
15F Short range radio
15G Short range radio antenna
15H Battery
15I Port
15J Screen controls
16 Cellular tower
17 Server memory
18 Other wireless service
20 App download
21 Uses of the Invention
21 Nearby devices
22 Hardware details
24 Location based access method
26 Transactions made with smart phone
28 Cloud in a pocket
30 Cloud insurance
32 Restoration after smart phone is lost or stolen
34 Pairing with personal computer or Mac
36 A Family uses the App
38 Digital Entities and Personas
40 Details of a Digital Entity and Personas
42 Sub-Partitions
44 Access to Partitions
46 Access Gate
48 A Company uses the App
50 Manager
52 Group Administration
54 Group Administrator
56 Group Members
58 Viewing the Digital Identity of an Employee
60 Company Identity for Bert
62 Bert's Company Personas
64 Using the App to work together on a project
66 Using the App to compose a report
68 Report
70 Personas on Mr. Jones' smart phone
72 Four Personas stored on a Remote Server
74 Four Personas with separate security levels and access rules
76 Automatic back-up and erasure of data for lost or stolen phones
77 Remote Servers in the Cloud, at Work or at Home
78 Added Security Module
80 Finger print reader
82 Voice reader
84 Retina scanner
86 Heartbeat sensor
88 UltraSecure Protection
90 Additional details of UltraSecure Protection

### SEQUENCE LISTING

Not applicable.

What is claimed is:

1. A method for adding computing functionality to a smart phone (12) comprising the steps of:
providing a smart phone (12);
said smart phone (12) including a CPU (15B);
said including a non-volatile memory (15A);
said non-volatile memory (15A) being divided into a plurality of dynamic partitions (42);
each of said plurality of dynamic partitions (42) being assigned to a persona of a user (10);
each of said plurality of dynamic partitions (42) being safeguarded by an access rule (46);
said smart phone (12) including a volatile memory (15C);
said smart phone (12) including a long range radio (15D);
said smart phone (12) including a short range radio (15F);
providing a transmitter (16, 18);
providing a server (14);
said transmitter (16, 18) being connected to said server (14);
said server (14) including a memory (17) for storing an App (13);
conveying said App (13) from said server (14) to said transmitter (16, 18);
conveying said App (13) from said transmitter (16, 18) to said smart phone (12) using said long range radio (15D) in said smart phone (12);
storing said App (13) in said non-volatile memory (15) of said smart phone (12);
running said App (13) on said CPU (15B); and
downloading said App (13) to a nearby separate information appliance (21A);
using said smart phone (12) to control the function of said nearby information appliance (21A) using said short range radio (15F).

2. A method as recited in claim 1, in which
said server (14) is located in the Cloud.

3. A method as recited in claim 1, in which
said server (14) is located in a user's office.

4. A method as recited in claim 1, in which
said server (14) is located in a user's home.

5. A method as recited in claim 1, in which
said smart phone (12) is purchased with said App (13) being pre-installed in the non-volatile memory (15B) of said smart phone (12).

6. A method as recited in claim 1, in which
said user (10) stores all his or her data in said smart phone (12), so that said smart phone becomes a personal Cloud.

7. A method as recited in claim 1, further comprising:
automatically backing-up the contents of said non-volatile memory (15B) in said smart phone (12) to the Cloud.

8. A method as recited in claim 1, further comprising:
erasing the data stored in said non-volatile memory (15B) in said smart phone (12) if said smart phone (12) is lost or stolen based on instructions from said user (10).

9. A method as recited in claim 1, in which
each of said plurality of dynamic partitions each contains information which is related to a particular topic.

10. A method as recited in claim 1, in which
said non-volatile memory (15B) is divided into a plurality of dynamic partitions (42);
each of said dynamic partitions (42) containing a persona.

11. A method as recited in claim 1, in which
said user (10) may store different kinds of content in each of said plurality of dynamic partitions (42).

12. A method as recited in claim 1, in which
each of said plurality dynamic partitions (42) may be configured with a different access rule (46) which allows others to access the contents of each of said plurality of dynamic partitions with other devices.

13. A method as recited in claim 1, in which
a group administrator (54) may have control over one of said plurality of dynamic partitions (42).

14. A method as recited in claim 1, in which
a group administrator (54) may have permission to view the contents of one of said plurality of dynamic partitions (42).

15. A method as recited in claim 1, in which
a group administrator (54) may aggregate the contents of dynamic partitions from a plurality of smart phones (12) to generate a report (68).

16. A method as recited in claim 1, in which
an external security device (80, 82, 84, 86) may be attached to said smart phone (12) to enhance its security.

17. A method for conveying digital content comprising the steps of:
providing a server; said server being connected to a network;
providing a client; said client being connected to said network;
requesting a content key from said server;
authenticating said request;
sending an encrypted session key to said client;
decrypting said encrypted session key;
sending a second request to said server;
authenticating said second request;
sending said content key encrypted with said encrypted session key to said client;
using said encrypted session key to recover said content key; and
using said recovered content to decrypt digital content.

18. A method for conveying digital content comprising the steps of:
setting up a security domain on a server;
registering a client on said security domain;
said server generating a content key and encrypting said content with said content key;
said server transferring said encrypted content to said client;
said client sending a request to said server for said content key;
said server authenticating said request;
generating a session key;
encrypting said session key;
sending response to said client;
decrypting said response to recover said session key;
sending a second request to said server;
authenticating said second request;
encrypting said content key with said session key;
sending second response to said client;
decrypting said second response with said session key to recover said content key; and
using said content key to decrypt digital content.

19. A method for securely transferring digital content comprising the steps of:
setting up a security domain on a server;
registering a client on said security domain;
dividing said digital content into a plurality of segments;
generating a plurality of segment keys, one for each of said plurality of segments;
encrypting each of said plurality of segments with one of said plurality of segment keys;
transferring said plurality of segments which have been encrypted to said client;
said client sending a request to said server for said plurality of segment keys;
authenticating said request;
generating a plurality of session keys, one for each of said plurality of segments;
encrypting said plurality of session keys;
sending a response to said client;
decrypting said response to recover said plurality of session keys;
sending a second request to said server;
authenticating said second request;
encrypting said remaining segment keys with said remaining session keys;
sending second response to said client;
decrypting said second response with said plurality of session keys to recover said plurality of segment keys which have been encrypted; and
using said plurality of segment keys to decrypt digital content.

20. A method for securely transferring digital content comprising the steps of:
setting up a security domain on a server including a quasi-public key crypto system and a quasi-public key, key exchange system;
registering a client on said security domain;
dividing digital content into a plurality of segments;
generating a random key for each segment;
encrypting said plurality of segments with said random keys using a symmetric key algorithm;
transferring said encrypted said plurality of segments to said client;
sending a request encrypted using said quasi-public key crypto system to said server for said segment keys;
authenticating said request for said segment keys from said client; generating session keys for each of said plurality of segments;
transforming said segment keys using said quasi-public key, key exchange protocol;
encrypting said transformed session keys using said quasi-public key crypto system;
sending response to said client;
decrypting said response using said quasi-public key crypto system;
recovering said session keys from said transformed session keys using said quasi-public key, key exchange protocol;
computing a hash of said session keys;
encrypting said hash using said symmetric key algorithm with said first session key;
sending a second request to said server;
authenticating said second request;
encrypting said remaining segment keys using said symmetric key algorithm with said remaining session keys;
sending second response to said client;
decrypting said second response using said symmetric key algorithm with said session keys to recover said encrypted segment keys; and
using said segment keys to decrypt digital content.

21. A method for conveying digital content comprising the steps of:
providing a server;
providing a client;
requesting a content key from said server;
authenticating said request;
sending an encrypted session key to said client;
decrypting said encrypted session key;
sending a second request to said server;
authenticating said second request;
sending said content key encrypted with said encrypted session key to said client;
using said encrypted session key to recover said content key; and
using said encrypted session key to decrypt digital content.

22. A method as recited in claim 1, in which
communications to and from said smart phone (12) are secured using the method recited in claim 21.

23. A method as recited in claim 1, in which
said smart phone (12) communicates with a friendly device which has been previously introduced to said smart phone (12) to establish a level of trust between said smart phone (12) and said friendly device.

24. A method as recited in claim 1, in which
said smart phone (12) communications “on-the-fly” with an unfriendly device.
